(19) United States
(12) Patent Application Publication
(10) Pub. No.: US 2026/0284643 A1
(43) Pub. Date: Sep. 24, 2026

(54) REACTORS FOR THE DECOMPOSITION OF NH3 AT HIGH TEMPERATURES

(71) Applicants: thyssenkrupp Uhde GmbH, Dortmund (DE); thyssenkrupp AG, Essen (DE)

(72) Inventors: Ruth KREMER, Bochum (DE); Tobias FISCHER, Guetersloh (DE); Thorsten BRAKHANE, Dortmund (DE)

(73) Assignees: thyssenkrupp Uhde GmbH, Dortmund (DE); thyssenkrupp AG, Essen (DE)

(21) Appl. No.: 19/490,123

(22) PCT Filed: Jun. 4, 2024
(86) PCT No.: PCT/EP2024/065354

§ 371 Date: Dec. 4, 2025

(30) Foreign Application Priority Data
Jun. 5, 2023 (DE) 10 2023 114 700.5
Jun. 5, 2023 (LU) LU103141

(51) Int. Cl. B01J 23/86; B01J 8/06; B01J 23/883; B01J 23/888; C01B 3/047

(52) U.S. Cl. CPC B01J 23/866; B01J 8/065; B01J 23/883; B01J 23/888; B01J 23/8885; C01B 3/047; B01J 2208/00274

(57) ABSTRACT

Reactors and reactor components have resistance to NH₃ and N₂ and possibly to H₂O at high temperatures and moderate pressure, and can be used in the catalytic decomposition of NH₃ to N₂ and H₂ on an industrial scales.

The priority of Luxembourg patent application No. LU 103141 of Jun. 5, 2023, is claimed.

The invention relates to reactors and reactor components that have a good resistance to NH₃ and N₂ and possibly to H₂O at high temperatures and moderate pressure, and so they can be used in the catalytic decomposition of NH₃ to N₂ and H₂ on an industrial scale.

H₂ can be obtained electrolytically from H₂O by means of renewable energies and then converted with N₂ to NH₃. NH₃ can be stored and transported much more safely than H₂. NH₃ can then be broken down again to H₂ and N₂. After being separated from N₂, H₂ finds a wide range of industrial applications.

The decomposition of NH₃ to give N₂ and H₂ is an endothermic reaction (ΔH°=45.9 kJ·mol⁻¹) in which the molar amount is doubled (2 NH₃→N₂+3 H₂), and so the reaction is fundamentally favored by high temperatures and low pressures. The higher the pressure, the higher the temperature must be in order to achieve satisfactory reaction yields.

The reaction temperature at which the catalytic decomposition of NH₃ proceeds is determined in particular by the choice of the NH₃ decomposition catalyst. A multitude of materials have been proposed as catalysts for the decomposition of NH₃, which are active at different temperatures (cf., for example, Il. Lucentini et al., Ind. Eng. Chem. Res. 2021, 60, 18560-18611).

For industrial implementations, however, many of these NH₃ decomposition catalysts are not usable economically on an industrial scale. Useful NH₃ decomposition catalysts for industrial implementations are in particular ruthenium-based and nickel-based NH₃ decomposition catalysts.

Ruthenium-based NH₃ decomposition catalysts have the advantage that conversions of more than 90% can be achieved at comparatively low temperatures. However, the maximum achievable conversions are limited, and so a considerable residual content of undecomposed NH₃ remains in the product gas, which may have to be separated off by additional measures in view of the amount.

Nickel-based NH₃ decomposition catalysts have the advantage that distinctly higher conversions can be achieved. Therefore, a small residual content at most of undecomposed NH₃ remains in the product gas, which can also be separated off by conventional measures for purification of H₂, in particular by pressure swing adsorption, without requiring additional measures. However, the temperatures required for nickel-based NH₃ decomposition catalysts are distinctly higher.

Numerous methods of catalytic decomposition of NH₃ are described in the prior art and different reactor types have been proposed (cf., for example, U.S. Pat. No. 4,704,267 A, US 2009/280024 A1, US 2020/0123006 A1, FR 1 469 045 A, GB 768 091 A, CN 111 957 270 A, CN 113 896 168 A, WO 2011/107279 A1, WO 2012/090739 A1, WO 2020/095467 A, WO 2021/257944 A1, WO 2022/096529 A1, WO 2022/153720 A1, WO 2022/243410 A1, WO 2022/265647 A1, WO 2022/265648 A1, WO 2022/265649 A1, WO 2022/265650 A1 and WO 2022/265651 A1).

Since the catalytic decomposition of NH₃ is endothermic and requires high temperatures, heat has to be introduced into the reactor. As well as electric heating systems, there have been proposals of combustion processes in particular, in which a combustion gas is burnt and the heat generated is utilized for the catalytic decomposition of NH₃.

Reactors suitable for such a reaction regime are in particular those designed analogously to primary reformers. The combustion gas and the reaction gas are physically separated from one another here by the reactor, but exchange heat with one another. The combustion gas is combusted with the aid of burners and with supply of combustion air in a combustion chamber, from which there is a heat flow into at least one physically separate reaction chamber. The reaction gas flows through the NH₃ decomposition catalyst positioned in the reaction chamber, and so that the catalyzed reaction proceeds therein. For example, several reaction chambers may be designed as tubes, through each of which NH₃ decomposition catalyst flows, and, in parallel, the reaction gas. These tubes are arranged, for example, as bundles within the combustion chamber, without mixing of combustion gas and reaction gas.

The materials from which the reaction chambers and also other components of such reactors are manufactured must withstand considerable loads at considerable temperatures. The temperatures generated here by the combustion of the combustion gas in the combustion chamber are well above the temperatures of the reaction gas in the reaction chamber. This temperature gradient forms the basis for the heat flow from the combustion chamber to the reaction chamber inter alia.

Where such reactors are used for the catalytic decomposition of NH₃ over nickel-based NH₃ decomposition catalysts, an additional complicating factor is that, in view of the high concentration of NH₃ or N₂, the high pressure and high temperatures, numerous metal alloys corrode as a result of external and/or internal nitridation (frequently referred to in this context as “nitration”).

R. P. Rubly et al., Oxidation of Metals Vol. 35, 3-4 (1991) relates to the internal nitridation of nickel-chromium alloys. The nitridation characteristics of nickel-chromium alloys are examined in ammonia-hydrogen mixtures in the range of 700-900° C. CrN was formed under all exposure conditions; Cr₂N could not be detected. The transition from internal to external nitride formation at 900° C. is between 30-40% Cr.

J. J. Barnes et al., Journal de Physique III, vol. 3, 1993, 167-174 discusses factors that influence the behavior of Fe-, Ni- and Co-based metal alloys with regard to nitridation at high temperatures (1093° C.).

K. Tjorko et al., Oxidation of Metals Vol. 44, 453-474 (1995), relates to a comparison of internal nitridation in NH₃ and N₂. Nitridation requires the dissociation of N₂ or NH₃. Dissociation of N₂ takes place to a significant extent only above about 700° C. Therefore, at temperatures below about 700° C., nitridation is determined by the presence of NH₃. Even at very high temperatures (1000° C.), nitridation with NH₃ is more significant than with N₂.

U. Krupp et al., Oxidation of Metals vol. 52, 277-298 (1999), relates to the internal nitridation of nickel-based alloys, in particular the behavior of binary and ternary alloys of the Ni—Cr—Al—Ti system.

U. Krupp et al., Oxidation of Metals vol. 52, 299-320 (1999), likewise relates to the internal nitridation of nickel-based alloys, in particular the behavior of quaternary Ni—Cr—Al—Ti alloys and a computer-based description with reference to the thermodynamic data, incorporated into a FEM diffusion calculation.

H. J. Grabke et al., Materials and Corrosion 2003, 54(11), 895-902 relates to studies in which iron, nickel, ferritic 1-18% Cr steels, austenitic 18% Cr-9% Ni and 20% Cr-31% Ni steels and a 16% CrNi base alloy at 500° C. were exposed to He-30% H₂O and 70% H₂O-30% NH₃, in order to compare the corrosion characteristics of these materials in water vapor as in conventional power plants with their behavior in an NH₃—H₂O mixture, i.e. under the conditions of the “Kalina cycle”.

G. Y. Lai, High-Temperature Corrosion and Materials Applications, ASM International, 2007, Chapter 4: Nitridation explains why nitridation occurs and how it attacks various metals, in some cases penetrating deeper than oxidation. Nitridation and its effects on metals and alloys in high-temperature air, and also in NH₃—H₂O, NH₃, H₂—N₂—NH₃ and N₂ environments, are discussed.

M. O. Cojocaru et al., Materials 2021, 14, 2432, relates to the effects of variation in the activity of nitrating agents by dilution of ammonia with nitrogen.

E. Wolowiec-Korecka et al., Coatings 2023, 13, 257, 1-12, relates to the stability of layer nitrides in the case of nitridation at low pressure.

It should also be noted that NH₃ is frequently spiked with traces of H₂O for storage and transport in order to reduce the risk of stress cracking corrosion for unalloyed steel. This increases the partial oxygen pressure at high temperatures in the reactor, and so not only nitridation but also oxidation can play a role. The nitridation of metal alloys in NH₃ (or in mixtures of NH₃, N₂ and H₂, as formed in the course of the decomposition reaction) at high temperatures, for example in the range of 650-750° C., has barely been studied to date, especially not in the presence of traces of H₂O.

The reverse process is the synthesis of NH₃ from N₂ and H₂ by the Haber-Bosch method.

American Iron and Steel Institute, A Designer's Handbook Series No. 9013, 1978, Nickel Institute, 4-23, relates to stainless steels for ammonia production.

With regard to suitable metal alloys for the catalytic decomposition of NH₃, there is barely any information available from Haber-Bosch process technology, since the temperatures are distinctly lower in the Haber-Bosch process. However, temperature has a crucial influence on nitridation. Austenitic steels are often sufficient for reactors and components in the Haber-Bosch process. They can be used at temperatures of up to about 480° C., and also at somewhat higher temperatures (up to about 510° C.) in the case of greater wall thicknesses. A further material suitable for the Haber-Bosch process is Alloy 600, but, according to The American Society of Mechanical Engineers (ASME) Boiler and Pressure Vessel Code (BPVC) Sec II-D, this is approved only up to temperatures of 649° C.

There is also barely any information available with regard to suitable metal alloys for the catalytic decomposition of NH₃ from technologies with an NH₃ atmosphere under supercritical conditions, for example for recovery of single nitride crystals. Single nitride crystals are typically recovered at distinctly lower temperatures of, for example, about 133° C. and correspondingly high pressures of, for example, 11.3 MPa. Moreover, a distinction should be made between the reaction mechanisms of electrochemical reactions at the surface (for example in the case of a fluid) on the one hand and of diffusion-controlled mechanisms in the base material and in the reaction layer (for example in the case of a gas) on the other. In supercritical media, the reaction mechanisms that proceed can typically be more similar to those of a fluid or those of a gas. This typically depends on the medium itself, and on further different parameters. For supercritical water, for example, density is a determining parameter. At low density the behavior is more similar to that of a gas, while at high density the behavior of a liquid is predominant (low-high boundary about 0.2 g/ml). In supercritical CO₂, for example, the water content, the content of impurities and temperature are determining parameters. At high temperatures, conventional high-temperature processes are predominant in dry CO₂. Traces of water lead to distinct material-removing corrosion. The supercritical behavior of CO₂ and NH₃ can be considered comparable in a first approximation. NH₃ often contains traces of water. In that case, as with supercritical CO₂, condensation would be possible, and hence not only gas phase reactions.

In addition to corrosion resistance at high temperatures in the presence of N₂, NH₃ and possibly H₂O, the other properties of the metal alloy are also crucial, in particular hardness, tensile strength, elongation, elongation at break, tensile strength, modulus of elasticity, density, electrical resistance, melting range, thermal conductivity, specific heat capacity, etc. Another factor is workability, especially weldability.

There is a need for improved reactors which can be used economically on an industrial scale for the catalytic decomposition of NH₃ to N₂ and H₂ and which, at high temperatures (e.g. 650-750° C.), have a satisfactory or prolonged service life compared to conventional reactors used for this purpose. The materials used for manufacture of the reactors should create a balance between satisfactory properties and procurement costs.

It is an object of the invention to provide improved reactors for the production of H₂ by catalytic decomposition of NH₃. The production of H₂ should be possible safely, economically and on an industrial scale.

This object is achieved by the subject matter of the claims.

A first aspect of the invention relates to a plant for production of H₂ by catalytic decomposition of NH₃ to give N₂ and H₂;
wherein the plant comprises a reactor containing an NH₃ decomposition catalyst;
wherein the reactor comprises at least one component formed at least partly from a metal alloy;
wherein the metal alloy comes into direct contact with the NH₃ and/or N₂ at least in one region of its surface in the course of operation of the reactor; preferably with NH₃, N₂ and H₂O or dissociation products thereof; and
wherein the metal alloy contains nickel, chromium or both nickel and chromium, where the total nickel and/or chromium content is at least 15% by weight, based on the total weight of the metal alloy.

For the purposes of the description, what is meant by total “A and/or B” content is that the metal alloy of the invention contains either (i) both A and B, in which case the total content relates to the sum total of the two individual contents of A and B, or (ii) does not contain B, such that the total content then relates to the content of A alone, or (iii) does not contain A, such that the total content then relates to the content of B alone.

The metal alloy preferably contains nickel and chromium with a total nickel and chromium content of at least 15% by weight, based on the total weight of the metal alloy.

In preferred embodiments, the metal alloy of the invention contains at least two metals selected from the group consisting of nickel, cobalt, chromium, iron, molybdenum, manganese, niobium, cerium, aluminum, titanium, silicon, tungsten, copper, boron, zirconium, lanthanum and yttrium.

In preferred embodiments, the metal alloy of the invention contains at least three metals selected from the group consisting of nickel, cobalt, chromium, iron, molybdenum, manganese, niobium, cerium, aluminum, titanium, silicon, tungsten, copper, boron, zirconium, lanthanum and yttrium.

In preferred embodiments, the metal alloy of the invention contains at least four metals selected from the group consisting of nickel, cobalt, chromium, iron, molybdenum, manganese, niobium, cerium, aluminum, titanium, silicon, tungsten, copper, boron, zirconium, lanthanum and yttrium.

In preferred embodiments, the metal alloy of the invention contains at least five metals selected from the group consisting of nickel, cobalt, chromium, iron, molybdenum, manganese, niobium, cerium, aluminum, titanium, silicon, tungsten, copper, boron, zirconium, lanthanum and yttrium.

It has been found that the content of nickel and possibly also cobalt is an important parameter for sufficient resistance to nitridation. This is in particular because nickel and cobalt in iron-based alloys reduce the solubility of nitrogen, making internal nitridation more difficult. In order to obtain sufficient stability to nitridation, the total content of nickel or nickel and cobalt is preferably at least 40% by weight, based on the total weight of the metal alloy.

It has also been found that chromium in itself is likely to be disadvantageous in terms of resistance to nitridation. This is in particular because chromium increases the solubility of nitrogen in nickel-based alloys and hence the tendency to nitridation.

However, as soon as the gas atmosphere additionally also contains H₂O in addition to N₂ and NH₃, other factors play an important role, in particular the formation of an outer oxide layer on the surface of the metal alloy. An outer oxide layer is formed when the partial pressure of O₂ is sufficiently high. The partial pressure of O₂ and H₂ is determined thermodynamically by the equilibrium 2 H₂O↔2 H₂+O₂. If the partial pressure of O₂ is lower than the equilibrium pressure of O₂ for the metal/metal oxide equilibrium, no oxide is formed.

It has been found that, in the presence of H₂O, chromium has a favorable effect in terms of corrosion resistance, since chromium forms the stable oxide Cr₂O₃. Cr₂O₃ is stable even at very low partial pressures of O₂, unlike iron oxides. Even a low content of a few ppm of H₂O can lead to an outer layer of Cr₂O₃, which distinctly reduces nitridation. This is the case, for example, when the NH₃ gas mixtures, for example at 900° C., contain only 45 ppm of H₂O. It has been found that the chromium content has to be high enough to form and maintain a sufficiently dense outer layer of Cr₂O₃. The latter means that the replenishment of chromium has to be assured in order to ensure the stable growth of an outer layer of Cr₂O₃. The chromium content preferably is at least 18% by weight, based on the total weight of the metal alloy.

In preferred embodiments, the metal alloy of the invention therefore contains at least 30% by weight, preferably at least 33% by weight, of nickel and/or cobalt (total content) and at least 15% by weight, preferably at least 19% by weight, of chromium, based in each case on the total weight of the metal alloy. In preferred embodiments, the metal alloy of the invention contains at least 40% by weight of nickel and/or cobalt (total content) and at least 20% by weight of chromium, based in each case on the total weight of the metal alloy.

In preferred embodiments, the metal alloy of the invention therefore contains at least 30% by weight, preferably at least 33% by weight, of nickel and at least 15% by weight, preferably at least 19% by weight, of chromium, based in each case on the total weight of the metal alloy. In preferred embodiments, the metal alloy of the invention contains at least 40% by weight of nickel and at least 20% by weight of chromium, based in each case on the total weight of the metal alloy.

In preferred embodiments, the metal alloy of the invention therefore contains at least 33% by weight of cobalt and at least 15% by weight of chromium, based in each case on the total weight of the metal alloy. In preferred embodiments, the metal alloy of the invention contains at least 40% by weight of cobalt and at least 20% by weight of chromium, based in each case on the total weight of the metal alloy.

In preferred embodiments, the metal alloy of the invention contains nickel, chromium and iron, where the nickel content is preferably greater than the chromium content.

In preferred embodiments, the metal alloy of the invention contains nickel, cobalt, chromium and iron, where the total nickel and cobalt content is preferably greater than the chromium content.

For the purposes of the description, a “reactor” is an apparatus for the catalytic decomposition of NH₃ to N₂ and H₂. The reactor of the invention is typically a delimited space that has been specially designed and prepared for the purpose, in order to allow and be able to control the catalytic decomposition of NH₃ to N₂ and H₂ under defined conditions.

For the purpose of the description, a “metal alloy” is a macroscopically homogeneous metallic material which is typically obtained by co-melting different metals, which may also include nonmetals and/or semimetals. The metals, nonmetals and/or semimetals may be in elemental form, in the form of intermetallic phases and/or in the form of other compounds. The metal alloy may be crystalline, semicrystalline or amorphous. Metals of particular importance in accordance with the invention that may be present in the metal alloy of the invention are nickel, cobalt, chromium and iron, but also optionally aluminum and titanium. Further metals that may be present in the metal alloy of the invention are, for example, molybdenum, tungsten, niobium, copper, aluminum, titanium, silicon, boron, lanthanum, manganese, vanadium, cerium, yttrium, zirconium, lead and others. Nonmetals and semimetals of particular importance in accordance with the invention that may be present in the metal alloy of the invention are boron, carbon, silicon, nitrogen, phosphorus, sulfur and others.

For the purposes of the description, an “NH₃ decomposition catalyst” catalyzes the decomposition of NH₃ to N₂ and H₂. In order to achieve yields of more than 90%, elevated temperatures of the NH₃ are typically required, preferably at least 500° C.

For the purpose of the description, what is meant by in direct contact with NH₃ and/or N₂” is that there is no further material at least in one region between the metal alloy and the NH₃ and/or N₂, and that the NH₃ and/or N₂ can interact with the surface of the metal alloy in at least this region. However, modifications to the surface of the metal alloy are permissible in the context of the invention for direct contact, for example the formation of outer layers of oxides and nitrides. The metal alloy, or its surface, does not have to completely come into contact with the NH₃ and/or N₂ over its full area. For instance, it is sufficient if there is at least one region in which NH₃ and/or N₂ can interact with the surface of the metal alloy. Since the NH₃ is decomposed in the reactor of the invention on its way from the inlet into the reactor to the outlet from the reactor, the amount of NH₃ at the inlet of the reactor is distinctly higher than at the outlet of the reactor in the course of operation of the reactor. The reverse is true of the amount of N₂ formed by decomposition of NH₃. Preferably, the metal alloy comes into direct contact with NH₃, N₂ and H₂O or dissociation products thereof (N₂, H₂ or O₂) at least in a region of its surface in the course of operation of the reactor.

Unless explicitly stated otherwise, all percentages are based on weight [% by weight]. For ranges defined with “±”, e.g. A±B, the numerical lower limit of the range is A-B and the numerical upper limit of the range is A+B. If the value for B is the same as for A, the lower limit is 0, and so the respective component can be completely absent. Unless expressly stated otherwise, the content data in % by weight do not add up to 100% by weight, i.e. other unmentioned components may also be present in addition to the components mentioned.

The plant of the invention comprises a reactor in which, in the course of operation of the plant, NH₃ is catalytically decomposed to form a product gas comprising N₂, H₂ and possibly undecomposed NH₃.

In preferred embodiments of the invention, the plant of the invention comprises one or more of the following apparatuses that are fluidically connected to one another:
(i) a device for storing liquid NH₃;
(ii) a device for heating and evaporating the liquid NH₃;
(iii) the reactor of the invention;
(iv) a device for purifying H₂ from the product gas; and
(v) a device for recovering process heat.

The reactor of the invention preferably comprises several chambers that are physically separated from one another. The reactor preferably comprises at least one reaction chamber and at least one combustion chamber.

The reactor of the invention is preferably of analogous design to a primary reformer.

The reactor of the invention preferably comprises
one or more combustion chambers for combustion of a combustion gas to generate heat of combustion and a flue gas (offgas); and
one or more reaction chambers for catalytic decomposition of NH₃ to produce a product gas comprising N₂, H₂ and possibly undecomposed NH₃.

Combustion chamber(s) and reaction chamber(s) are preferably physically separated from one another, such that there is no mixing of combustion gas on the one hand and NH₃ (reactant gas) or product gas on the other in the course of operation of the reactor.

Combustion chamber(s) and reaction chamber(s) are preferably configured such that, in the course of operation of the reactor, there is a heat flow of the heat of combustion generated from combustion chamber(s) into reaction chamber(s). In the course of operation of the reactor, this heat flow preferably serves to maintain the endothermic catalytic decomposition of NH₃.

In preferred embodiments of the invention, the reaction chambers(s) are tubular, i.e. have a cylindrical shape. Preferably, a plurality of such tubular reaction chambers are arranged parallel to one another as a bundle in a common combustion chamber.

Each combustion chamber preferably contains one or more burners for combustion of combustion gas. The flame formed here is preferably in spatial proximity to the outer wall of at least one reaction chamber containing NH₃ decomposition catalyst in the course of operation of the reactor. In the course of operation of the reactor, heat of combustion then preferably flows from the inside of the combustion chamber through the wall of the at least one reaction chamber and thus introduces heat as far as the NH₃ decomposition catalyst through which NH₃ flows and over which the endothermic decomposition of NH₃ proceeds.

The reactor of the invention also comprises at least one component formed at least partly from a metal alloy which comes into direct contact with the NH₃ and/or N₂ in the course of operation of the reactor.

Preferably, the component is a reaction chamber or an element of a reaction chamber, wherein the NH₃ decomposition catalyst is positioned in the interior of the reaction chamber. The reactor of the invention then preferably contains a reaction chamber comprising the component and the NH₃ decomposition catalyst.

In preferred embodiments of the invention, the component is formed entirely from the metal alloy of the invention, i.e. the component consists entirely of the metal alloy.

If the component formed entirely from the metal alloy of the invention is a reaction chamber with the NH₃ decomposition catalyst positioned in the interior thereof, the wall of the reaction chamber consists of the component and thus entirely of the metal alloy. The inner surface of the wall of the reaction chamber faces the NH₃ decomposition catalyst, and the metal alloy of which the wall of the reaction chamber consists comes into direct contact with the NH₃ and/or N₂ at least in one region in the course of operation of the reactor.

If the component formed entirely from the metal alloy of the invention is an element of a reaction chamber with the NH₃ decomposition catalyst positioned in the interior thereof, the wall of the reaction chamber preferably comprises the component. For example, the component may be tubular and in a concentric arrangement within another tubular element together with which it forms the wall of the reaction chamber. The inner surface of the component then faces the NH₃ decomposition catalyst, and the metal alloy of which the inner component of the wall consists comes into direct contact with the NH₃ and/or N₂ at least in one region in the course of operation of the reactor.

In other preferred embodiments, the component is only partly formed from the metal alloy of the invention. For example, the component may be multilayered, in which case one of the layers of the component, preferably an external layer, is formed from the metal alloy of the invention, i.e. this layer of the component consists of the metal alloy, whereas other layers of the component may consist of other materials and/or of inventive alloys of the same or different composition.

If the component formed only partly from the metal alloy of the invention is a reaction chamber with the NH₃ decomposition catalyst positioned in the interior thereof, the component may be a reaction chamber having a multilayer wall, where the multilayer wall has an inner layer and an outer layer. The inner surface of the inner layer of the component then faces the NH₃ decomposition catalyst, and the metal alloy of which the inner layer consists comes into direct contact with the NH₃ and/or N₂ at least in one region in the course of operation of the reactor.

Preferably, the entire inner surface area of the reaction chamber which faces the NH₃ decomposition catalyst and which comes into direct contact with the NH₃ and/or N₂ in the course of operation of the reactor is formed from the metal alloy.

Preferably, the entire inner surface area of the reaction chamber which comes into direct contact with the NH₃ and/or N₂ in the course of operation of the reactor is formed from the metal alloy.

The reactor of the invention contains an NH₃ decomposition catalyst. If NH₃ flows through the NH₃ decomposition catalyst under reaction conditions, it catalyzes the decomposition of NH₃ to N₂ and H₂.

Useful NH₃ decomposition catalysts in accordance with the invention include various materials. The reaction temperature at which the catalytic decomposition of NH₃ proceeds is determined in particular by the choice of the NH₃ decomposition catalyst.

In preferred embodiments of the invention, the NH₃ decomposition catalyst is catalytically active with respect to the decomposition of NH₃ at a temperature in the region of at least 500° C., preferably at least 520° C., more preferably at least 540° C., even more preferably at least 550° C., most preferably at least 580° C. and in particular at least 600° C. What is meant here by “catalytically active” is that conversions of at least 90% of decomposition products N₂ and H₂ are obtained in relation to the amount of NH₃ used (measured under standard conditions in pure NH₃ at a pressure of 1013 hPa and a space velocity of 36 Lg_{cat}⁻¹).

In preferred embodiments of the invention, the NH₃ decomposition catalyst with respect to the decomposition of NH₃ has an apparent activation energy Eₐₚₚ of at least 50 kJ·mol⁻¹, more preferably at least 75 kJ·mol⁻¹, even more preferably at least 100 kJ·mol⁻¹, most preferably at least 125 kJ·mol⁻¹, and in particular at least 150 kJ·mol⁻¹. Methods of determining apparent activation energy Eₐₚₚ are known to a person skilled in the art, for example by determination from Arrhenius plots based on measurements under standard conditions in pure NH₃ at a pressure of 1013 hPa and a space velocity of 36 Lg_{cat}⁻¹.

In preferred embodiments of the invention, a nickel-based NH₃ decomposition catalyst is used. The reaction temperature determines the equilibrium conversion. At 900° C. and a pressure of 20 bar, the decomposition of NH₃ proceeds nearly quantitatively. At 650° C., the conversion of NH₃ is about 98.5%, and at 500° C. only about 95%. Preference is given in accordance with the invention to establishing reaction temperatures in the range from about 600° C. to about 900° C., preferably about 600° C. to about 700° C., so as to achieve a high conversion. In terms of energy balance and conversion, optimal reaction temperatures range from about 630° C. to 640° C. Nickel-based NH₃ decomposition catalysts are advantageous in spite of the comparatively high reaction temperature. Because of the high conversion, the remaining residual content of undecomposed NH₃ in the product gas is comparatively low, and so it is preferable to dispense with any separate separation of undecomposed NH₃ for recovery thereof. Instead, the combined separation of N₂ and undecomposed NH₃ from the product gas is then combined by pressure swing adsorption in the course of purification of H₂.

The NH₃ decomposition catalyst preferably comprises supported nickel. Preferred support materials are selected from the group consisting of Al₂O₃, MgO, SiO₂, mesoporous SiO₂ (e.g. MCF-17, MCM-41, SBA-15), zeolite (e.g. HY, H-ZSM-5), BaMnO₃, BaTiO₃, BaZrO₃, CaMnO₃, CaTiO₃, CaZrO₃, CeO₂, Gd₂O₃, GdAlO₃, KNbO₃, La₂O₃, LaAlO₃, MnO₂, NaNbO₃, Nb₂O₅, Sm₂O₃, SmAlO₃, SrMnO₃, SrTiO₃, SrZrO₃, TiO₂, Y₂O₃, ZrO₂, carbon (e.g. CNTs, SWCNTs, AX-21, MSC-30, MESO-C, GNP, activated carbon, graphene, graphene oxide), attapulgite, hydrocalumite, sepiolite, and mixtures thereof.

The metal alloy of the invention contains nickel and chromium with a total nickel and chromium content of at least 15% by weight, based on the total weight of the metal alloy.

In preferred embodiments of the invention, the total nickel and chromium content is at least 15.5% by weight, preferably at least 16.0% by weight, preferably at least 16.5% by weight, more preferably at least 17.0% by weight, even more preferably at least 17.5% by weight, most preferably at least 18.0% by weight, and in particular at least 18.5% by weight, based in each case on the total weight of the metal alloy.

In preferred embodiments of the invention, the total nickel and chromium content is at least 20% by weight, preferably at least 25% by weight, more preferably at least 30% by weight, even more preferably at least 35% by weight, most preferably at least 40% by weight, and in particular at least 45% by weight, based in each case on the total weight of the metal alloy.

In preferred embodiments of the invention, the total nickel and chromium content is at least 50% by weight, preferably at least 55% by weight, more preferably at least 60% by weight, even more preferably at least 65% by weight, most preferably at least 70% by weight, and in particular at least 75% by weight, based in each case on the total weight of the metal alloy.

In preferred embodiments of the invention, the total nickel and chromium content is at least 80% by weight, preferably at least 85% by weight, more preferably at least 90% by weight, based in each case on the total weight of the metal alloy.

In preferred embodiments of the invention, the total nickel and chromium content is at most 85% by weight, preferably at most 80% by weight, more preferably at most 75% by weight, even more preferably at most 70% by weight, most preferably at most 65% by weight, and in particular at most 60% by weight, based in each case on the total weight of the metal alloy.

The metal alloy of the invention contains nickel.

In preferred embodiments of the invention, the nickel content is at least 5.0% by weight, preferably at least 10% by weight, more preferably at least 15% by weight, even more preferably at least 20% by weight, most preferably at least 30% by weight, and in particular at least 35% by weight, based in each case on the total weight of the metal alloy.

In preferred embodiments of the invention, the nickel content is at least 40% by weight, preferably at least 45% by weight, more preferably at least 50% by weight, even more preferably at least 55% by weight, most preferably at least 60% by weight, and in particular at least 65% by weight, based in each case on the total weight of the metal alloy.

In preferred embodiments of the invention, the nickel content is at least 70% by weight, preferably at least 75% by weight, based in each case on the total weight of the metal alloy.

In preferred embodiments of the invention, the nickel content, with ascending preference, is in the range of 20±15% by weight, 20±10% by weight, or 20±5.0% by weight, based in each case on the total weight of the metal alloy.

In preferred embodiments of the invention, the nickel content, with ascending preference, is in the range of 30±25% by weight, 30±20% by weight, 30±15% by weight, 30±10% by weight, or 30±5.0% by weight, based in each case on the total weight of the metal alloy.

In preferred embodiments of the invention, the nickel content, with ascending preference, is in the range of 40±35% by weight, 40±30% by weight, 40±25% by weight, 40±20% by weight, 40±15% by weight, 40±10% by weight, or 40±5.0% by weight, based in each case on the total weight of the metal alloy.

In preferred embodiments of the invention, the nickel content, with ascending preference, is in the range of 50±30% by weight, 50±25% by weight, 50±20% by weight, 50±15% by weight, 50±10% by weight, or 50±5.0% by weight, based in each case on the total weight of the metal alloy.

In preferred embodiments of the invention, the nickel content, with ascending preference, is in the range of 60±20% by weight, 60±15% by weight, 60±10% by weight, or 60±5.0% by weight, based in each case on the total weight of the metal alloy.

In preferred embodiments of the invention, the nickel content, with ascending preference, is in the range of 70±10% by weight, or 70±5.0% by weight, based in each case on the total weight of the metal alloy.

preferred embodiments of the invention, the nickel content is at most 60% by weight, preferably at most 55% by weight, more preferably at most 50% by weight, even more preferably at most 45% by weight, most preferably at most 40% by weight, and in particular at most 35% by weight, based in each case on the total weight of the metal alloy.

The metal alloy of the invention contains chromium.

In preferred embodiments of the invention, the chromium content is at most 40% by weight, preferably at most 38% by weight, more preferably at most 36% by weight, even more preferably at most 35% by weight, most preferably at most 34% by weight, and in particular at most 32% by weight, based in each case on the total weight of the metal alloy.

In preferred embodiments of the invention, the chromium content is at most 30% by weight, preferably at most 28% by weight, more preferably at most 26% by weight, even more preferably at most 24% by weight, most preferably at most 22% by weight, and in particular at most 20% by weight, based in each case on the total weight of the metal alloy.

In other preferred embodiments, the chromium content is at least 12% by weight, preferably at least 15% by weight, more preferably at least 18% by weight, even more preferably at least 21% by weight, most preferably at least 24% by weight, and in particular at least 27% by weight, based in each case on the total weight of the metal alloy.

In preferred embodiments of the invention, the chromium content, with ascending preference, is in the range of 10±7.5% by weight, 10±5.0% by weight, or 10±2.5% by weight, based in each case on the total weight of the metal alloy.

In preferred embodiments of the invention, the chromium content, with ascending preference, is in the range of 12.5±10% by weight, 12.5±17.5% by weight, 12.5±5.0% by weight, or 12.5±2.5% by weight, based in each case on the total weight of the metal alloy.

In preferred embodiments of the invention, the chromium content, with ascending preference, is in the range of 15±12.5% by weight, 15±10% by weight, 15±7.5% by weight, 15±5.0% by weight, or 15±2.5% by weight, based in each case on the total weight of the metal alloy.

In preferred embodiments of the invention, the chromium content, with ascending preference, is in the range of 17.5±15% by weight, 17.5±12.5% by weight, 17.5±10% by weight, 17.5±7.5% by weight, 17.5±5.0% by weight, or 17.5±2.5% by weight, based in each case on the total weight of the metal alloy.

In preferred embodiments of the invention, the chromium content, with ascending preference, is in the range of 19±17.5% by weight, 19±15% by weight, 19±12.5% by weight, 19±10% by weight, 19±7.5% by weight, 19±5.0% by weight, or 19±2.5% by weight, based in each case on the total weight of the metal alloy.

In preferred embodiments of the invention, the chromium content, with ascending preference, is in the range of 20±17.5% by weight, 20±15% by weight, 20±12.5% by weight, 20±10% by weight, 20±7.5% by weight, 20±5.0% by weight, or 20±2.5% by weight, based in each case on the total weight of the metal alloy.

In preferred embodiments of the invention, the chromium content, with ascending preference, is in the range of 22.5±20% by weight, 22.5±17.5% by weight, 22.5±15% by weight, 22.5±12.5% by weight, 22.5±10% by weight, 22.5±7.5% by weight, 22.5±5.0% by weight, or 22.5±2.5% by weight, based in each case on the total weight of the metal alloy.

In preferred embodiments of the invention, the chromium content, with ascending preference, is in the range of 25±22.5% by weight, 25±20% by weight, 25±17.5% by weight, 25±15% by weight, 25±12.5% by weight, 25±10% by weight, 25±7.5% by weight, 25±5.0% by weight, or 25±2.5% by weight, based in each case on the total weight of the metal alloy.

In preferred embodiments of the invention, the chromium content, with ascending preference, is in the range of 27.5±25% by weight, 27.5±22.5% by weight, 27.5±20% by weight, 27.5±17.5% by weight, 27.5±15% by weight, 27.5±12.5% by weight, 27.5±10% by weight, 27.5±7.5% by weight, 27.5±5.0% by weight, or 27.5±2.5% by weight, based in each case on the total weight of the metal alloy.

In preferred embodiments of the invention, the chromium content, with ascending preference, is in the range of 30±27.5% by weight, 30±25% by weight, 30±22.5% by weight, 30±20% by weight, 30±17.5% by weight, 30±15% by weight, 30±12.5% by weight, 30±10% by weight, 30±7.5% by weight, 30±5.0% by weight, or 30±2.5% by weight, based in each case on the total weight of the metal alloy.

In preferred embodiments of the invention, the chromium content, with ascending preference, is in the range of 32.5±30% by weight, 32.5±27.5% by weight, 32.5±25% by weight, 32.5±22.5% by weight, 32.5±20% by weight, 32.5±17.5% by weight, 32.5±15% by weight, 32.5±12.5% by weight, 32.5±10% by weight, 32.5±7.5% by weight, 32.5±5.0% by weight, or 32.5±2.5% by weight, based in each case on the total weight of the metal alloy.

Preferred embodiments Z1 to Z72 have the following nickel and chromium content in % by weight, based in each case on the total weight of the metal alloy:

| [% by wt.] | Z1 | Z2 | Z3 | Z4 | Z5 | Z6 | Z7 | Z8 | Z9 | Z10 |
|---|---|---|---|---|---|---|---|---|---|---|
| Ni | 15 ± 10 | 20 ± 10 | 25 ± 10 | 30 ± 10 | 35 ± 10 | 40 ± 10 | 45 ± 10 | 50 ± 10 | 55 ± 10 | 60 ± 10 |
| Cr | 15 ± 10 | 15 ± 10 | 15 ± 10 | 15 ± 10 | 15 ± 10 | 15 ± 10 | 15 ± 10 | 15 ± 10 | 15 ± 10 | 15 ± 10 |

| | Z11 | Z12 | Z13 | Z14 | Z15 | Z16 | Z17 | Z18 | Z19 | Z20 |
|---|---|---|---|---|---|---|---|---|---|---|
| Ni | 65 ± 10 | 70 ± 10 | 15 ± 10 | 20 ± 10 | 25 ± 10 | 30 ± 10 | 35 ± 10 | 40 ± 10 | 45 ± 10 | 50 ± 10 |
| Cr | 15 ± 10 | 15 ± 10 | 20 ± 10 | 20 ± 10 | 20 ± 10 | 20 ± 10 | 20 ± 10 | 20 ± 10 | 20 ± 10 | 20 ± 10 |
| | Z21 | Z22 | Z23 | Z24 | Z25 | Z26 | Z27 | Z28 | Z29 | Z30 |
| Ni | 55 ± 10 | 60 ± 10 | 65 ± 10 | 70 ± 10 | 15 ± 10 | 20 ± 10 | 25 ± 10 | 30 ± 10 | 35 ± 10 | 40 ± 10 |
| Cr | 20 ± 10 | 20 ± 10 | 20 ± 10 | 20 ± 10 | 25 ± 10 | 25 ± 10 | 25 ± 10 | 25 ± 10 | 25 ± 10 | 25 ± 10 |
| | Z31 | Z32 | Z33 | Z34 | Z35 | Z36 | Z37 | Z38 | Z39 | Z40 |
| N | 45 ± 10 | 50 ± 10 | 55 ± 10 | 60 ± 10 | 65 ± 10 | 70 ± 10 | 15 ± 5 | 20 ± 5 | 25 ± 5 | 30 ± 5 |
| Cr | 25 ± 10 | 25 ± 10 | 25 ± 10 | 25 ± 10 | 25 ± 10 | 25 ± 10 | 15 ± 5 | 15 ± 5 | 15 ± 5 | 15 ± 5 |
| | Z41 | Z42 | Z43 | Z44 | Z45 | Z46 | Z47 | Z48 | Z49 | Z50 |
| Ni | 35 ± 5 | 40 ± 5 | 45 ± 5 | 50 ± 5 | 55 ± 5 | 60 ± 5 | 65 ± 5 | 70 ± 5 | 15 ± 5 | 20 ± 5 |
| Cr | 15 ± 5 | 15 ± 5 | 15 ± 5 | 15 ± 5 | 15 ± 5 | 15 ± 5 | 15 ± 5 | 15 ± 5 | 20 ± 5 | 20 ± 5 |
| | Z51 | Z52 | Z53 | Z54 | Z55 | Z56 | Z57 | Z58 | Z59 | Z60 |
| Ni | 25 ± 5 | 30 ± 5 | 35 ± 5 | 40 ± 5 | 45 ± 5 | 50 ± 5 | 55 ± 5 | 60 ± 5 | 65 ± 5 | 70 ± 5 |
| Cr | 20 ± 5 | 20 ± 5 | 20 ± 5 | 20 ± 5 | 20 ± 5 | 20 ± 5 | 20 ± 5 | 20 ± 5 | 20 ± 5 | 20 ± 5 |
| | Z61 | Z62 | Z63 | Z64 | Z65 | Z66 | Z67 | Z68 | Z69 | Z70 |
| Ni | 15 ± 5 | 20 ± 5 | 25 ± 5 | 30 ± 5 | 35 ± 5 | 40 ± 5 | 45 ± 5 | 50 ± 5 | 55 ± 5 | 60 ± 5 |
| Cr | 25 ± 5 | 25 ± 5 | 25 ± 5 | 25 ± 5 | 25 ± 5 | 25 ± 5 | 25 ± 5 | 25 ± 5 | 25 ± 5 | 25 ± 5 |
| | Z71 | Z72 | Z73 | Z74 | Z75 | Z76 | Z77 | Z78 | Z79 | Z80 |
| Ni | 65 ± 5 | 70 ± 5 | 15 ± 5 | 20 ± 5 | 25 ± 5 | 30±5 | 35 ± 5 | 40 ± 5 | 45 ± 5 | 50 ± 5 |
| Cr | 25 ± 5 | 25 ± 5 | 30 ± 5 | 30 ± 5 | 30 ± 5 | 30 ± 5 | 30 ± 5 | 30 ± 5 | 30 ± 5 | 30 ± 5 |

| | Z81 | Z82 | Z83 | Z84 |
|---|---|---|---|---|
| Ni | 55 ± 5 | 60 ± 5 | 65 ± 5 | 70 ± 5 |
| Cr | 30 ± 5 | 30 ± 5 | 30 ± 5 | 30 ± 5 |

Preferably, the metal alloy of the invention additionally contains cobalt.

In preferred embodiments of the invention, the total content of nickel and optionally cobalt is at least 20% by weight, preferably at least 25% by weight, more preferably at least 30% by weight, even more preferably at least 35% by weight, most preferably at least 40% by weight, and in particular at least 45% by weight, based in each case on the total weight of the metal alloy.

In preferred embodiments of the invention, the total content of nickel and optionally cobalt is at least 50% by weight, preferably at least 54% by weight, more preferably at least 58% by weight, even more preferably at least 62% by weight, most preferably at least 66% by weight, and in particular at least 70% by weight, based in each case on the total weight of the metal alloy. In preferred embodiments of the invention, the total content of nickel and optionally cobalt is at least 70% by weight, preferably at least 75% by weight, based in each case on the total weight of the metal alloy.

In preferred embodiments of the invention, the total content of nickel and optionally cobalt, with ascending preference, is in the range of 20±15% by weight, 20±10% by weight, or 20±5.0% by weight, based in each case on the total weight of the metal alloy.

In preferred embodiments of the invention, the total content of nickel and optionally cobalt, with ascending preference, is in the range of 30±25% by weight, 30±20% by weight, 30±15% by weight, 30±10% by weight, or 30±5.0% by weight, based in each case on the total weight of the metal alloy.

In preferred embodiments of the invention, the total content of nickel and optionally cobalt, with ascending preference, is in the range of 40±35% by weight, 40±30% by weight, 40±25% by weight, 40±20% by weight, 40±15% by weight, 40±10% by weight, or 40±5.0% by weight, based in each case on the total weight of the metal alloy.

In preferred embodiments of the invention, the total content of nickel and optionally cobalt, with ascending preference, is in the range of 50±30% by weight, 50±25% by weight, 50±20% by weight, 50±15% by weight, 50±10% by weight, or 50±5.0% by weight, based in each case on the total weight of the metal alloy.

In preferred embodiments of the invention, the total content of nickel and optionally cobalt, with ascending preference, is in the range of 60±20% by weight, 60±15% by weight, 60±10% by weight, or 60±5.0% by weight, based in each case on the total weight of the metal alloy.

In preferred embodiments of the invention, the total content of nickel and optionally cobalt, with ascending preference, is in the range of 70±10% by weight, or 70±5.0% by weight, based in each case on the total weight of the metal alloy.

In preferred embodiments of the invention, the total content of nickel and optionally cobalt is at most 60% by weight, preferably at most 55% by weight, more preferably at most 50% by weight, even more preferably at most 45% by weight, most preferably at most 40% by weight, and in particular at most 35% by weight, based in each case on the total weight of the metal alloy.

For the purposes of the description, what is meant by “total content of nickel and optionally cobalt” is that the metal alloy of the invention contains either (i) both nickel and cobalt, in which case the total content relates to the sum total of the two individual contents of nickel and cobalt, or (ii) does not contain cobalt, such that the total content then relates to the content of nickel alone.

In preferred embodiments of the invention, the cobalt content is at least 4.0% by weight, preferably at least 8.0% by weight, more preferably at least 12% by weight, even more preferably at least 16% by weight, most preferably at least 20% by weight, and in particular at least 24% by weight, based in each case on the total weight of the metal alloy.

In other preferred embodiments, the cobalt content is at most 15% by weight, preferably at most 12.5% by weight, more preferably at most 10% by weight, even more preferably at most 7.5% by weight, most preferably at most 5.0% by weight, and in particular at most 2.5% by weight, based in each case on the total weight of the metal alloy.

In other preferred embodiments, the metal alloy of the invention contains very small amounts of cobalt at most, preferably at most 1.0% by weight, more preferably at most 0.5% by weight, even more preferably at most 0.1% by weight; most preferably, cobalt is nominally absent.

Preferred embodiments A1 to A72 have the following contents of nickel, optionally cobalt and chromium in % by weight, based in each case on the total weight of the metal alloy:

| [% by wt.] | Ä1 | Ä2 | Ä3 | Ä4 | Ä5 | Ä6 | Ä7 | Ä8 | Ä9 | Ä10 |
|---|---|---|---|---|---|---|---|---|---|---|
| Ni | 15 ± 10 | 20 ± 10 | 25 ± 10 | 30 ± 10 | 35 ± 10 | 40 ± 10 | 45 ± 10 | 50 ± 10 | 55 ± 10 | 60 ± 10 |
| Co | 10 ± 10 | 10 ± 10 | 10 ± 10 | 10 ± 10 | 10 ± 10 | 10 ± 10 | 10 ± 10 | 10 ± 10 | 10 ± 10 | 10 ± 10 |
| Cr | 15 ± 10 | 15 ± 10 | 15 ± 10 | 15 ± 10 | 15 ± 10 | 15 ± 10 | 15 ± 10 | 15 ± 10 | 15 ± 10 | 15 ± 10 |

| | Ä11 | Ä12 | Ä13 | Ä14 | Ä15 | Ä16 | Ä17 | Ä18 | Ä19 | Ä20 |
|---|---|---|---|---|---|---|---|---|---|---|
| Ni | 65 ± 10 | 70 ± 10 | 15 ± 10 | 20 ± 10 | 25 ± 10 | 30 ± 10 | 35 ± 10 | 40 ± 10 | 45 ± 10 | 50 ± 10 |
| Co | 10 ± 10 | 10 ± 10 | 10 ± 10 | 10 ± 10 | 10 ± 10 | 10 ± 10 | 10 ± 10 | 10 ± 10 | 10 ± 10 | 10 ± 10 |
| Cr | 15 ± 10 | 15 ± 10 | 20 ± 10 | 20 ± 10 | 20 ± 10 | 20 ± 10 | 20 ± 10 | 20 ± 10 | 20 ± 10 | 20 ± 10 |
| | Ä21 | Ä22 | Ä23 | Ä24 | Ä25 | Ä26 | Ä27 | Ä28 | Ä29 | Ä30 |
| Ni | 55 ± 10 | 60 ± 10 | 65 ± 10 | 70 ± 10 | 15 ± 10 | 20 ± 10 | 25 ± 10 | 30 ± 10 | 35 ± 10 | 40 ± 10 |
| Co | 10 ± 10 | 10 ± 10 | 10 ± 10 | 10 ± 10 | 10 ± 10 | 10 ± 10 | 10 ± 10 | 10 ± 10 | 10 ± 10 | 10 ± 10 |
| Cr | 20 ± 10 | 20 ± 10 | 20 ± 10 | 20 ± 10 | 25 ± 10 | 25 ± 10 | 25 ± 10 | 25 ± 10 | 25 ± 10 | 25 ± 10 |
| | Ä31 | Ä32 | Ä33 | Ä34 | Ä35 | Ä36 | Ä37 | Ä38 | Ä39 | Ä40 |
| Ni | 45 ± 10 | 50 ± 10 | 55 ± 10 | 60 ± 10 | 65 ± 10 | 70 ± 10 | 15 ± 5 | 20 ± 5 | 25 ± 5 | 30 ± 5 |
| Co | 10 ± 10 | 10 ± 10 | 10 ± 10 | 10 ± 10 | 10 ± 10 | 10 ± 10 | 5 ± 5 | 5 ± 5 | 5 ± 5 | 5 ± 5 |
| Cr | 25 ± 10 | 25 ± 10 | 25 ± 10 | 25 ± 10 | 25 ± 10 | 25 ± 10 | 15 ± 5 | 15 ± 5 | 15 ± 5 | 15 ± 5 |
| | Ä41 | Ä42 | Ä43 | Ä44 | Ä45 | Ä46 | Ä47 | Ä48 | Ä49 | Ä50 |
| Ni | 35 ± 5 | 40 ± 5 | 45 ± 5 | 50 ± 5 | 55 ± 5 | 60 ± 5 | 65 ± 5 | 70 ± 5 | 15 ± 5 | 20 ± 5 |
| Co | 5 ± 5 | 5 ± 5 | 5 ± 5 | 5 ± 5 | 5 ± 5 | 5 ± 5 | 5 ± 5 | 5 ± 5 | 5 ± 5 | 5 ± 5 |
| Cr | 15 ± 5 | 15 ± 5 | 15 ± 5 | 15 ± 5 | 15 ± 5 | 15 ± 5 | 15 ± 5 | 15 ± 5 | 20 ± 5 | 20 ± 5 |
| | Ä51 | Ä52 | Ä53 | Ä54 | Ä55 | Ä56 | Ä57 | Ä58 | Ä59 | Ä60 |
| Ni | 25 ± 5 | 30 ± 5 | 35 ± 5 | 40 ± 5 | 45 ± 5 | 50 ± 5 | 55 ± 5 | 60 ± 5 | 65 ± 5 | 70 ± 5 |
| Co | 5 ± 5 | 5 ± 5 | 5 ± 5 | 5 ± 5 | 5 ± 5 | 5 ± 5 | 5 ± 5 | 5 ± 5 | 5 ± 5 | 5 ± 5 |
| Cr | 20 ± 5 | 20 ± 5 | 20 ± 5 | 20 ± 5 | 20 ± 5 | 20 ± 5 | 20 ± 5 | 20 ± 5 | 20 ± 5 | 20 ± 5 |
| | Ä61 | Ä62 | Ä63 | Ä64 | Ä65 | Ä66 | Ä67 | Ä68 | Ä69 | Ä70 |
| Ni | 15 ± 5 | 20 ± 5 | 25 ± 5 | 30 ± 5 | 35 ± 5 | 40 ± 5 | 45 ± 5 | 50 ± 5 | 55 ± 5 | 60 ± 5 |
| Co | 5 ± 5 | 5 ± 5 | 5 ± 5 | 5 ± 5 | 5 ± 5 | 5 ± 5 | 5 ± 5 | 5 ± 5 | 5 ± 5 | 5 ± 5 |
| Cr | 25 ± 5 | 25 ± 5 | 25 ± 5 | 25 ± 5 | 25 ± 5 | 25 ± 5 | 25 ± 5 | 25 ± 5 | 25 ± 5 | 25 ± 5 |

| | Ä71 | Ä72 |
|---|---|---|
| Ni | 65 ± 5 | 70 ± 5 |
| Co | 5 ± 5 | 5 ± 5 |
| Cr | 25 ± 5 | 25 ± 5 |

It has been found that the content of nickel or the total content of nickel and cobalt in the metal alloy of the invention has an important influence on the solubility of nitrogen and hence on the nitridation. As the nickel content or total content of nickel and cobalt rises, the solubility of nitrogen in the metal alloy decreases. The lower the solubility for nitrogen, the lower the tendency to (internal) nitridation as well.

It has also been found that the higher solubility of nitrogen in austenitic steels causes them to be more prone to (internal) nitridation than nickel-base materials. In nickel-base materials, a nickel content in the range from 40% to 50% by weight can ensure satisfactory resistance to nitridation.

It appears that the chromium content has a promoting effect on internal nitridation at relatively high temperatures, probably also after long periods of exposure. A high chromium content can therefore be disadvantageous.

If the NH₃ has been spiked with traces of water or the NH₃ contains traces of O₂, partial pressure of O₂ is increased, this can have a beneficial effect on the stability of outer oxide layers on the surface of the metal alloy. It has been found that chromium has a favorable effect thereon.

The metal alloy of the invention may additionally contain aluminum and/or titanium. Even though aluminum and titanium are not preferred in themselves, it may be advantageous, for example for reasons of strength, to use raw materials for the production of the metal alloy of the invention that may contain comparatively small amounts of aluminum and/or titanium. Even though aluminum and titanium are not in themselves preferred, certain amounts can be tolerated.

Both aluminum and titanium are frequently present in technical metal alloys, although not always in a large amount, in order to increase mechanical strength and creep resistance. Aluminum can additionally improve oxidation resistance. Both metals have a marked tendency to form nitrides at high temperatures in contact with nitrogen, especially deep within the material (internal nitridation). It has been found that the depth of internal nitridation of metal alloys containing aluminum and/or titanium is elevated compared to metal alloys containing neither aluminum nor titanium. It has also been found that higher chromium contents additionally promote the internal nitridation of aluminum and titanium.

It has been found that the comparatively large volume of the nitrides formed (nitride precipitates) leads to unwanted embrittlement of the metal alloys.

It has also been found that the volume stresses associated with the internal nitridation and/or embrittlement can in turn lead to flaking of the outer layer on the surface of the metal alloy. This outer layer may consist of oxides and/or nitrides. The flaking of the outer layer results in local loss of its protective effect, which increases the speed of the unwanted nitridation. The absorption of nitrogen is then promoted owing to lack of an outer layer.

It appears that water (or traces of oxygen) increases the ductility of external outer nitride layers, so as to reduce the risk of flaking. Therefore, if the NH₃ is contaminated with traces of water, this may have a favorable effect on the stability of the nitride outer layers and in this way may suppress or reduce internal nitridation.

Moreover, internal nitridation can lead to depletion and hence lowering of creep and nitridation resistance. Owing to depletion of outer layer-forming elements such as Cr, Si or Al, the protective outer layer may fail.

Therefore, internal nitridation should be suppressed as far as possible or proceed to a comparatively small extent at most.

In preferred embodiments of the invention, the total aluminum and/or titanium content is at most 5.5% by weight, preferably at most 5.0% by weight, more preferably at most 4.5% by weight, even more preferably at most 4.0% by weight, most preferably at most 3.5% by weight, and in particular at most 3.0% by weight, based in each case on the total weight of the metal alloy.

For the purposes of the description, what is meant by “total aluminum and/or titanium content” is that the metal alloy of the invention contains either (i) both aluminum and titanium, in which case the total content relates to the sum total of the two individual contents of aluminum and titanium, or (ii) does not contain aluminum, such that the total content then relates to the content of titanium alone, or (iii) does not contain titanium, such that the total content then relates to the content of aluminum alone.

In preferred embodiments of the invention, the metal alloy of the invention contains at most very small amounts of aluminum and/or titanium, preferably at most 1.0% by weight, more preferably at most 0.5% by weight, even more preferably at most 0.1% by weight; most preferably, aluminum and titanium are nominally absent.

The metal alloy of the invention may additionally contain aluminum.

In preferred embodiments of the invention, the aluminum content is preferably at most 6.0% by weight, preferably at most 5.5% by weight, more preferably at most 5.0% by weight, even more preferably at most 4.5% by weight, most preferably at most 4.0% by weight, and in particular at most 3.5% by weight, based in each case on the total weight of the metal alloy.

In preferred embodiments of the invention, the aluminum content is preferably at most 3.0% by weight, preferably at most 2.5% by weight, more preferably at most 2.0% by weight, even more preferably at most 1.5% by weight, most preferably at most 1.0% by weight, and in particular at most 0.5% by weight, based in each case on the total weight of the metal alloy.

Like Cr₂O₃, Al₂O₃ is very stable, even at low partial pressures of 02. However, outer oxide layers of Al₂O₃ grow even more slowly than outer oxide layers of Cr₂O₃, since the formation of Al₂O₃ is kinetically inhibited at comparatively low temperatures. In addition, it has been found that relatively high aluminum contents (>5% by weight) make it difficult to weld the metal alloy, and that there is additionally a significant tendency to form highly embrittling nitrides.

In other preferred embodiments, the metal alloy of the invention contains very small amounts of aluminum at most, preferably at most 1.0% by weight, more preferably at most 0.5% by weight, even more preferably at most 0.1% by weight; most preferably, aluminum is nominally absent.

The metal alloy of the invention may additionally contain titanium.

In preferred embodiments of the invention, the titanium content is preferably at most 4.5% by weight, preferably at most 4.0% by weight, more preferably at most 3.5% by weight, even more preferably at most 3.0% by weight, most preferably at most 2.5% by weight, and in particular at most 2.0% by weight, based in each case on the total weight of the metal alloy.

In other preferred embodiments, the metal alloy of the invention contains very small amounts of titanium at most, preferably at most 1.0% by weight, more preferably at most 0.6% by weight, even more preferably at most 0.5% by weight, most preferably at most 0.1% by weight; in particular, titanium is nominally absent.

Preferably, the metal alloy of the invention additionally contains iron.

In preferred embodiments of the invention, the metal alloy of the invention is a steel, preferably an austenitic steel.

In preferred embodiments of the invention, the iron content is at most 85% by weight, preferably at most 80% by weight, more preferably at most 75% by weight, even more preferably at most 70% by weight, most preferably at most 65% by weight, and in particular at most 50% by weight, based in each case on the total weight of the metal alloy.

In preferred embodiments of the invention, the iron content is at most 45% by weight, preferably at most 40% by weight, more preferably at most 35% by weight, even more preferably at most 30% by weight, most preferably at most 25% by weight, and in particular at most 20% by weight, based in each case on the total weight of the metal alloy.

In preferred embodiments of the invention, the iron content is at most 15% by weight, preferably at most 10% by weight, more preferably at most 5.0% by weight, based in each case on the total weight of the metal alloy.

In preferred embodiments of the invention, the iron content is in the range of 10±5% by weight, based on the total weight of the metal alloy.

In preferred embodiments of the invention, the iron content, with ascending preference, is in the range of 20±15% by weight, 20±10% by weight, or 20±5.0% by weight; based in each case on the total weight of the metal alloy.

In preferred embodiments of the invention, the iron content, with ascending preference, is in the range of 30±25% by weight, 30±20% by weight, 30±15% by weight, 30±10% by weight, or 30±5.0% by weight, based in each case on the total weight of the metal alloy.

In preferred embodiments of the invention, the iron content, with ascending preference, is in the range of 40±35% by weight, 40±30% by weight, 40±25% by weight, 40±20% by weight, 40±15% by weight, 40±10% by weight, or 40±5.0% by weight, based in each case on the total weight of the metal alloy.

In preferred embodiments of the invention, the iron content, with ascending preference, is in the range of 50±30% by weight, 50±25% by weight, 50±20% by weight, 50±15% by weight, 50±10% by weight, or 50±5.0% by weight, based in each case on the total weight of the metal alloy.

In preferred embodiments of the invention, the iron content, with ascending preference, is in the range of 60±20% by weight, 60±15% by weight, 60±10% by weight, or 60±5.0% by weight, based in each case on the total weight of the metal alloy.

In preferred embodiments of the invention, the iron content, with ascending preference, is in the range of 70±10% by weight, or 70±5.0% by weight, based in each case on the total weight of the metal alloy.

In other preferred embodiments, the metal alloy of the invention contains small amounts of iron at most, preferably at most 1.5% by weight, more preferably at most 1.0% by weight, even more preferably at most 0.5% by weight, most preferably at most 0.1% by weight; in particular, iron is nominally absent.

Preferably, the metal alloy of the invention contains silicon.

It has been found that SiO₂ is more thermodynamically stable than Cr₂O₃. It is firstly therefore possible for SiO₂ to form on the surface instead of Cr₂O₃ in low-oxygen atmospheres and hence hinder nitridation. Secondly, silicon contents are metallurgically limited. Therefore, there is usually no formation of a dense SiO₂ layer, which reduces the protective effect. In the case that Cr₂O₃ is stable, SiO₂ can form at the inner phase boundary, which likewise reduces the tendency to nitridation. But here too, the SiO₂ layer is usually not continuous or mixed oxides are formed.

In preferred embodiments of the invention, the silicon content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

It is known that additions of silicon can improve the stability of particular metal alloys to oxidation. However, experimental evidence suggests that silicon does not appear to increase stability to nitridation.

In preferred embodiments of the invention, the silicon content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

Preferably, the metal alloy of the invention contains carbon.

In preferred embodiments of the invention, the carbon content is at least 0.010% by weight, preferably at least 0.020% by weight, more preferably at least 0.030% by weight, even more preferably at least 0.040% by weight, most preferably at least 0.050% by weight, and in particular at least 0.060% by weight, based in each case on the total weight of the metal alloy.

In preferred embodiments of the invention, the carbon content is in the range of 0.1% to 0.5% by weight, based on the total weight of the metal alloy. This is preferably the case for cast alloys in particular.

In preferred embodiments of the invention, the carbon content is at most 0.10% by weight, preferably at most 0.09% by weight, more preferably at most 0.08% by weight, even more preferably at most 0.07% by weight, most preferably at most 0.06% by weight, and in particular at most 0.05% by weight, based in each case on the total weight of the metal alloy.

In iron-based alloys, atomic hydrogen can react with carbides such as iron carbide to form methane. Low-alloyed chromium steels and chromium-molybdenum steels become increasingly more stable to this form of high-temperature embrittlement (HTHA) as the Cr content increases, since chromium carbides are much more stable than iron carbide. Therefore, austenitic steels and nickel-base alloys have good stability to high-temperature embrittlement. However, nickel-base alloys can become brittle as a result of “trapping” of the hydrogen on chromium carbides in the course of thermal aging.

Preferably, the metal alloy of the invention contains molybdenum.

In preferred embodiments of the invention, the molybdenum content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the metal alloy contains molybdenum and the molybdenum content is at least 1.0% by weight, preferably at least 2.0% by weight, more preferably at least 3.0% by weight, even more preferably at least 4.0% by weight, most preferably at least 5.0% by weight, and in particular at least 6.0% by weight, based in each case on the total weight of the metal alloy.

In preferred embodiments of the invention, the molybdenum content is at most 12% by weight, preferably at most 11% by weight, more preferably at most 10% by weight, even more preferably at most 9.0% by weight, most preferably at most 8.0% by weight, and in particular at most 7.0% by weight, based in each case on the total weight of the metal alloy.

In preferred embodiments of the invention, the molybdenum content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of molybdenum at most, preferably at most 1.0% by weight, more preferably at most 0.5% by weight, even more preferably at most 0.1% by weight; most preferably, molybdenum is nominally absent.

In preferred embodiments of the invention, the metal alloy contains molybdenum and the total content of nickel, chromium and molybdenum is at most 85% by weight, preferably at most 80% by weight, more preferably at most 75% by weight, even more preferably at most 70% by weight, most preferably at most 65% by weight, and in particular at most 60% by weight, based in each case on the total weight of the metal alloy.

Preferably, the metal alloy of the invention contains vanadium.

In preferred embodiments of the invention, the vanadium content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the vanadium content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of vanadium at most, preferably at most 1.0% by weight, more preferably at most 0.5% by weight, even more preferably at most 0.1% by weight; most preferably, vanadium is nominally absent.

Preferably, the metal alloy of the invention contains manganese.

It has been found that manganese tends to form spinels (MnCr₂O₄) in the presence of chromium that are more thermodynamically stable than Cr₂O₃ and are formed especially at low partial oxygen pressures. The growth rate of the spinels is higher than the growth rate of Cr₂O₃.

In preferred embodiments of the invention, the manganese content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the manganese content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of manganese at most, preferably at most 1.0% by weight, more preferably at most 0.5% by weight, even more preferably at most 0.2% by weight; most preferably, manganese is nominally absent.

Preferably, the metal alloy of the invention contains zirconium.

In preferred embodiments of the invention, the zirconium content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the zirconium content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of zirconium at most, preferably at most 1.0% by weight, more preferably at most 0.5% by weight, even more preferably at most 0.1% by weight; most preferably, zirconium is nominally absent.

Preferably, the metal alloy of the invention contains copper.

In preferred embodiments of the invention, the copper content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the copper content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of copper at most, preferably at most 1.0% by weight, more preferably at most 0.5% by weight, even more preferably at most 0.1% by weight; most preferably, copper is nominally absent.

Preferably, the metal alloy of the invention contains niobium.

In preferred embodiments of the invention, the niobium content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the niobium content is at most 5.5% by weight, preferably at most 5.0% by weight, more preferably at most 4.5% by weight, even more preferably at most 4.0% by weight, most preferably at most 3.5% by weight, and in particular at most 3.0% by weight, based in each case on the total weight of the metal alloy.

In other preferred embodiments, the metal alloy of the invention contains very small amounts of niobium at most, preferably at most 1.5% by weight, more preferably at most 1.0% by weight, even more preferably at most 0.5% by weight, even more preferably at most 0.1% by weight; most preferably, niobium is nominally absent.

Preferably, the metal alloy of the invention contains tungsten.

In preferred embodiments of the invention, the tungsten content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the metal alloy contains tungsten and the tungsten content is at least 1.0% by weight, preferably at least 2.0% by weight, more preferably at least 3.0% by weight, even more preferably at least 4.0% by weight, most preferably at least 5.0% by weight, and in particular at least 6.0% by weight, based in each case on the total weight of the metal alloy.

In preferred embodiments of the invention, the tungsten content is at most 20% by weight, preferably at most 19% by weight, more preferably at most 18% by weight, even more preferably at most 17% by weight, most preferably at most 16% by weight, and in particular at most 15% by weight, based in each case on the total weight of the metal alloy.

In preferred embodiments of the invention, the tungsten content is at most 5.0% by weight, preferably at most 4.0% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of tungsten at most, preferably at most 1.0% by weight, more preferably at most 0.5% by weight, even more preferably at most 0.1% by weight; most preferably, tungsten is nominally absent.

In preferred embodiments of the invention, the metal alloy contains tungsten and the total content of nickel, chromium and tungsten is at most 95% by weight, preferably at most 90% by weight, more preferably at most 85% by weight, even more preferably at most 80% by weight, most preferably at most 75% by weight, and in particular at most 70% by weight, based in each case on the total weight of the metal alloy.

Preferably, the metal alloy of the invention contains molybdenum and tungsten.

In preferred embodiments of the invention, the metal alloy contains molybdenum and tungsten and the total content of nickel, chromium, molybdenum and tungsten is at most 95% by weight, preferably at most 90% by weight, more preferably at most 85% by weight, even more preferably at most 80% by weight, most preferably at most 75% by weight, and in particular at most 70% by weight, based in each case on the total weight of the metal alloy.

In preferred embodiments of the invention, the content of {[(molybdenum content)+0.5×(tungsten content)]} is less than 1.5% by weight.

In preferred embodiments of the invention, the content of {[(molybdenum content)+0.5×(tungsten content)]} is at most 1.4% by weight, preferably at most 1.2% by weight, more preferably at most 1.0% by weight, even more preferably at most 0.8% by weight, most preferably at most 0.6% by weight, and in particular at most 0.4% by weight, based in each case on the total weight of the metal alloy.

In preferred embodiments of the invention, the content of {[(molybdenum content)+0.5×(tungsten content)]} is more than 8.5% by weight.

In preferred embodiments of the invention, the content of {[(molybdenum content)+0.5×(tungsten content)]} is at least 8.6% by weight, preferably at least 8.8% by weight, more preferably at least 9.0% by weight, even more preferably at least 10% by weight, most preferably at least 13% by weight, and in particular at least 16% by weight, based in each case on the total weight of the metal alloy.

In preferred embodiments of the invention, the content of (1.8×chromium/{[(molybdenum content)+0.5×(tungsten content)]}) is less than 3.0% by weight.

In preferred embodiments of the invention, the content of (1.8×chromium/{[(molybdenum content)+0.5×(tungsten content)]}) is at most 2.9% by weight, preferably at most 2.6% by weight, more preferably at most 2.3% by weight, even more preferably at most 2.0% by weight, most preferably at most 1.7% by weight, and in particular at most 1.4% by weight, based in each case on the total weight of the metal alloy.

In preferred embodiments of the invention, the content of (1.8×chromium/{[(molybdenum content)+0.5×(tungsten content)]}) is more than 10% by weight.

In preferred embodiments of the invention, the content of (1.8×chromium/{[(molybdenum content)+0.5×(tungsten content)]}) is at least 30% by weight, preferably at least 50% by weight, more preferably at least 70% by weight, even more preferably at least 75% by weight, most preferably at least 80% by weight, and in particular at least 85% by weight, based in each case on the total weight of the metal alloy.

Preferably, the metal alloy of the invention contains a rare earth metal, preferably selected from the group consisting of scandium, lanthanum, cerium, praseodymium, neodymium, promethium, samarium, europium, yttrium, gadolinium, terbium, dysprosium, holmium, erbium, thulium, ytterbium and lutetium; more preferably scandium, lanthanum, cerium, neodymium and yttrium. It has been found that rare earths (especially cerium and yttrium) in the case of external nitridation (low partial oxygen pressure) can improve the adhesion of the nitride.

In preferred embodiments of the invention, the total rare earth metal content is at least 0.01% by weight, preferably at least 0.02% by weight, more preferably at least 0.03% by weight, even more preferably at least 0.04% by weight, most preferably at least 0.05% by weight, and in particular at least 0.06% by weight, based in each case on the total weight of the metal alloy.

In preferred embodiments of the invention, the total rare earth metal content is at most 0.6% by weight, preferably at most 0.5% by weight, more preferably at most 0.4% by weight, even more preferably at most 0.3% by weight, most preferably at most 0.2% by weight, and in particular at most 0.1% by weight, based in each case on the total weight of the metal alloy.

In other preferred embodiments, the metal alloy of the invention contains very small amounts of rare earth metals at most, preferably at most 0.10% by weight, more preferably at most 0.09% by weight, even more preferably at most 0.08% by weight; most preferably, rare earth metals are nominally absent.

Preferably, the metal alloy of the invention contains cerium.

In preferred embodiments of the invention, the cerium content is at least 0.01% by weight, preferably at least 0.02% by weight, more preferably at least 0.03% by weight, even more preferably at least 0.04% by weight, most preferably at least 0.05% by weight, and in particular at least 0.06% by weight, based in each case on the total weight of the metal alloy.

In preferred embodiments of the invention, the cerium content is at most 0.6% by weight, preferably at most 0.5% by weight, more preferably at most 0.4% by weight, even more preferably at most 0.3% by weight, most preferably at most 0.2% by weight, and in particular at most 0.1% by weight, based in each case on the total weight of the metal alloy.

In other preferred embodiments, the metal alloy of the invention contains very small amounts of cerium at most, preferably at most 1.0% by weight, more preferably at most 0.5% by weight, even more preferably at most 0.1% by weight; most preferably, cerium is nominally absent.

Preferably, the metal alloy of the invention contains yttrium.

In preferred embodiments of the invention, the yttrium content is at least 0.01% by weight, preferably at least 0.02% by weight, more preferably at least 0.03% by weight, even more preferably at least 0.04% by weight, most preferably at least 0.05% by weight, and in particular at least 0.06% by weight, based in each case on the total weight of the metal alloy.

In preferred embodiments of the invention, the yttrium content is at most 0.6% by weight, preferably at most 0.5% by weight, more preferably at most 0.4% by weight, even more preferably at most 0.3% by weight, most preferably at most 0.2% by weight, and in particular at most 0.1% by weight, based in each case on the total weight of the metal alloy.

In other preferred embodiments, the metal alloy of the invention contains very small amounts of yttrium at most, preferably at most 0.10% by weight, more preferably at most 0.09% by weight, even more preferably at most 0.08% by weight; most preferably, yttrium is nominally absent.

Preferably, the metal alloy of the invention contains lanthanum.

In preferred embodiments of the invention, the lanthanum content is at least 0.01% by weight, preferably at least 0.02% by weight, more preferably at least 0.03% by weight, even more preferably at least 0.04% by weight, most preferably at least 0.05% by weight, and in particular at least 0.06% by weight, based in each case on the total weight of the metal alloy.

In preferred embodiments of the invention, the lanthanum content is at most 0.6% by weight, preferably at most 0.5% by weight, more preferably at most 0.4% by weight, even more preferably at most 0.3% by weight, most preferably at most 0.2% by weight, and in particular at most 0.15% by weight, based in each case on the total weight of the metal alloy.

In other preferred embodiments, the metal alloy of the invention contains very small amounts of lanthanum at most, preferably at most 0.10% by weight, more preferably at most 0.09% by weight, even more preferably at most 0.08% by weight; most preferably, lanthanum is nominally absent.

Preferably, the metal alloy of the invention contains boron.

In preferred embodiments of the invention, the boron content is at least 0.1% by weight, preferably at least 0.2% by weight, more preferably at least 0.3% by weight, even more preferably at least 0.4% by weight, most preferably at least 0.5% by weight, and in particular at least 0.6% by weight, based in each case on the total weight of the metal alloy.

In preferred embodiments of the invention, the boron content is at most 4.0% by weight, preferably at most 3.5% by weight, more preferably at most 3.0% by weight, even more preferably at most 2.5% by weight, most preferably at most 2.0% by weight, and in particular at most 1.5% by weight, based in each case on the total weight of the metal alloy.

In other preferred embodiments, the metal alloy of the invention contains very small amounts of boron at most, preferably at most 0.1% by weight, more preferably at most 0.01% by weight, even more preferably at most 0.001% by weight; most preferably, boron is nominally absent.

Preferably,
the total content of nickel and optionally cobalt is at least 54% by weight,
the chromium content is at most 24% by weight, and
the total aluminum and/or titanium content is not more than 2.1% by weight, based in each case on the total weight of the metal alloy.

Preferably,
the total content of nickel and optionally cobalt is at least 57% by weight, and
the chromium content is at least 26% by weight, based in each case on the total weight of the metal alloy.

Preferably,
the total content of nickel and optionally cobalt is at least 30% by weight,
the chromium content is in the range from 15% to 35% by weight,
the aluminum content is at most 2.5% by weight, and
the titanium content is at most 0.6% by weight, based in each case on the total weight of the metal alloy.

Preferably,
the total content of nickel and optionally cobalt is at least 30% by weight,
the chromium content is in the range from 19% to 35% by weight,
the aluminum content is at most 2.5% by weight, and
the titanium content is at most 0.6% by weight,
based in each case on the total weight of the metal alloy.

Preferably, the metal alloy is selected from the group consisting of metal alloys A1 to A12, B1 to B17, C1 to C17, D1 to D17, or E1 to E17, which each contain, based on the total weight of the metal alloy, the following content of chromium and nickel in % by weight, where further constituents not listed in the tables may be present in each case:

| | Cr | Ni |
|---|---|---|
| A1 | 15.5 ± 4.5 | 74.8 ± 15.6 |
| A2 | 22 ± 3.0 | 64.5 ± 19.5 |
| A3 | 25 ± 3.0 | 63 ± 9.0 |
| A4 | 23 ± 6.0 | 60.5 ± 7.5 |
| A5 | 22 ± 3.0 | 57 ± 3.0 |
| A6 | 16 ± 3.0 | 57 ± 18.0 |
| A7 | 22 ± 6.0 | 44.5 ± 3.0 |
| A8 | 21.5 ± 6.0 | 42 ± 12.0 |
| A9 | 28 ± 3.0 | 40.1 ± 14.7 |
| A10 | 25 ± 3.0 | 35 ± 3.0 |
| A11 | 16 ± 3.0 | 35 ± 6.0 |
| A12 | 20.5 ± 4.5 | 31.5 ± 4.5 |
| A13 | 23 ± 3.0 | 31 ± 3.0 |
| A14 | 25 ± 3.0 | 20.5 ± 4.5 |
| A15 | 25 ± 3.0 | 20.5 ± 4.5 |
| A16 | 16 ± 3.0 | 13 ± 3.0 |
| A17 | 21 ± 3.0 | 11 ± 3.0 |
| | Cr | Ni |
| B1 | 15.5 ± 3.8 | 74.8 ± 13.0 |
| B2 | 22 ± 2.5 | 64.5 ± 16.3 |
| B3 | 25 ± 2.5 | 63 ± 7.5 |
| B4 | 23 ± 5.0 | 60.5 ± 6.3 |
| B5 | 22 ± 2.5 | 57 ± 2.5 |
| B6 | 16 ± 2.5 | 57 ± 15.0 |
| B7 | 22 ± 5.0 | 44.5 ± 2.5 |
| B8 | 21.5 ± 5.0 | 42 ± 10.0 |
| B9 | 28 ± 2.5 | 40.1 ± 12.3 |
| B10 | 25 ± 2.5 | 35 ± 2.5 |
| B11 | 16 ± 2.5 | 35 ± 5.0 |
| B12 | 20.5 ± 3.8 | 31.5 ± 3.8 |
| B13 | 23 ± 2.5 | 31 ± 2.5 |
| B14 | 25 ± 2.5 | 20.5 ± 3.8 |
| B15 | 25 ± 2.5 | 20.5 ± 3.8 |
| B16 | 16 ± 2.5 | 13 ± 2.5 |
| B17 | 21 ± 2.5 | 11 ± 2.5 |
| | Cr | Ni |
| C1 | 15.5 ± 3.0 | 74.8 ± 10.4 |
| C2 | 22 ± 2.0 | 64.5 ± 13.0 |
| C3 | 25 ± 2.0 | 63 ± 6.0 |
| C4 | 23 ± 4.0 | 60.5 ± 5.0 |
| C5 | 22 ± 2.0 | 57 ± 2.0 |
| C6 | 16 ± 2.0 | 57 ± 12.0 |
| C7 | 22 ± 4.0 | 44.5 ± 2.0 |
| C8 | 21.5 ± 4.0 | 42 ± 8.0 |
| C9 | 28 ± 2.0 | 40.1 ± 9.8 |
| C10 | 25 ± 2.0 | 35 ± 2.0 |
| C11 | 16 ± 2.0 | 35 ± 4.0 |
| C12 | 20.5 ± 3.0 | 31.5 ± 3.0 |
| C13 | 23 ± 2.0 | 31 ± 2.0 |
| C14 | 25 ± 2.0 | 20.5 ± 3.0 |
| C15 | 25 ± 2.0 | 20.5 ± 3.0 |
| C16 | 16 ± 2.0 | 13 ± 2.0 |
| C17 | 21 ± 2.0 | 11 ± 2.0 |
| | Cr | Ni |
| D1 | 15.5 ± 2.3 | 74.8 ± 7.8 |
| D2 | 22 ± 1.5 | 64.5 ± 9.8 |
| D3 | 25 ± 1.5 | 63 ± 4.5 |
| D4 | 23 ± 3.0 | 60.5 ± 3.8 |
| D5 | 22 ± 1.5 | 57 ± 1.5 |
| D6 | 16 ± 1.5 | 57 ± 9.0 |
| D7 | 22 ± 3.0 | 44.5 ± 1.5 |
| D8 | 21.5 ± 3.0 | 42 ± 6.0 |
| D9 | 28 ± 1.5 | 40.1 ± 7.4 |
| D10 | 25 ± 1.5 | 35 ± 1.5 |
| D11 | 16 ± 1.5 | 35 ± 3.0 |
| D12 | 20.5 ± 2.3 | 31.5 ± 2.3 |
| D13 | 23 ± 1.5 | 31 ± 1.5 |
| D14 | 25 ± 1.5 | 20.5 ± 2.3 |
| D15 | 25 ± 1.5 | 20.5 ± 2.3 |
| D16 | 16 ± 1.5 | 13 ± 1.5 |
| D17 | 21 ± 1.5 | 11 ± 1.5 |
| | Cr | Ni |
| E1 | 15.5 ± 1.5 | 74.8 ± 5.2 |
| E2 | 22 ± 1.0 | 64.5 ± 6.5 |
| E3 | 25 ± 1.0 | 63 ± 3.0 |
| E4 | 23 ± 2.0 | 60.5 ± 2.5 |
| E5 | 22 ± 1.0 | 57 ± 1.0 |
| E6 | 16 ± 1.0 | 57 ± 6.0 |
| E7 | 22 ± 2.0 | 44.5 ± 1.0 |
| E8 | 21.5 ± 2.0 | 42 ± 4.0 |
| E9 | 28 ± 1.0 | 40.1 ± 4.9 |
| E10 | 25 ± 1.0 | 35 ± 1.0 |
| E11 | 16 ± 1.0 | 35 ± 2.0 |
| E12 | 20.5 ± 1.5 | 31.5 ± 1.5 |
| E13 | 23 ± 1.0 | 31 ± 1.0 |
| E14 | 25 ± 1.0 | 20.5 ± 1.5 |
| E15 | 25 ± 1.0 | 20.5 ± 1.5 |
| E16 | 16 ± 1.0 | 13 ± 1.0 |
| E17 | 21 ± 1.0 | 11 ± 1.0 |

Preferably, the metal alloy is selected from the group consisting of metal alloys F1 to F12, G1 to G17, H1 to H17, I1 to I17, or J1 to J17, which each contain, based on the total weight of the metal alloy, the following content of optionally iron, chromium and nickel in % by weight, where further constituents not listed in the tables may be present in each case:

| | Fe | Cr | Ni |
|---|---|---|---|
| F1 | 8.0 ± 6.0 | 15.5 ± 4.5 | 74.8 ± 15.6 |
| F2 | 7.5 ± 7.5 | 22 ± 3.0 | 64.5 ± 19.5 |
| F3 | 9.5 ± 4.5 | 25 ± 3.0 | 63 ± 9.0 |
| F4 | 27.0 ± 27.0 | 23 ± 6.0 | 60.5 ± 7.5 |
| F5 | 4.5 ± 4.5 | 22 ± 3.0 | 57 ± 3.0 |
| F6 | 5.5 ± 4.5 | 16 ± 3.0 | 57 ± 18.0 |
| F7 | 4.5 ± 4.5 | 22 ± 6.0 | 44.5 ± 3.0 |
| F8 | 29 ± 27.0 | 21.5 ± 6.0 | 42 ± 12.0 |
| F9 | 3.0 ± 3.0 | 28 ± 3.0 | 40.1 ± 14.7 |
| F10 | 39.2 ± 8.4 | 25 ± 3.0 | 35 ± 3.0 |
| F11 | 48 ± 12.0 | 16 ± 3.0 | 35 ± 6.0 |
| F12 | 47 ± 12.0 | 20.5 ± 4.5 | 31.5 ± 4.5 |
| F13 | 45.2 ± 8.4 | 23 ± 3.0 | 31 ± 3.0 |
| F14 | 52.5 ± 7.5 | 25 ± 3.0 | 20.5 ± 4.5 |
| F15 | 51.7 ± 6.9 | 25 ± 3.0 | 20.5 ± 4.5 |
| F16 | 70.7 ± 6.9 | 16 ± 3.0 | 13 ± 3.0 |
| F17 | 66.7 ± 9.9 | 21 ± 3.0 | 11 ± 3.0 |
| | Fe | Cr | Ni |
| G1 | 8.0 ± 5.0 | 15.5 ± 3.8 | 74.8 ± 13.0 |
| G2 | 6.3 ± 6.3 | 22 ± 2.5 | 64.5 ± 16.3 |
| G3 | 9.5 ± 3.8 | 25 ± 2.5 | 63 ± 7.5 |
| G4 | 22.5 ± 22.5 | 23 ± 5.0 | 60.5 ± 6.3 |
| G5 | 3.8 ± 3.8 | 22 ± 2.5 | 57 ± 2.5 |
| G6 | 5.5 ± 3.8 | 16 ± 2.5 | 57 ± 15.0 |
| G7 | 3.8 ± 3.8 | 22 ± 5.0 | 44.5 ± 2.5 |
| G8 | 29 ± 22.5 | 21.5 ± 5.0 | 42 ± 10.0 |
| G9 | 2.5 ± 2.5 | 28 ± 2.5 | 40.1 ± 12.3 |
| G10 | 39.2 ± 7.0 | 25 ± 2.5 | 35 ± 2.5 |
| G11 | 48 ± 10.0 | 16 ± 2.5 | 35 ± 5.0 |
| G12 | 47 ± 10.0 | 20.5 ± 3.8 | 31.5 ± 3.8 |
| G13 | 45.2 ± 7.0 | 23 ± 2.5 | 31 ± 2.5 |
| G14 | 52.5 ± 6.3 | 25 ± 2.5 | 20.5 ± 3.8 |
| G15 | 51.7 ± 5.8 | 25 ± 2.5 | 20.5 ± 3.8 |
| G16 | 70.7 ± 5.8 | 16 ± 2.5 | 13 ± 2.5 |
| G17 | 66.7 ± 8.3 | 21 ± 2.5 | 112.5 |
| | Fe | Cr | Ni |
| H1 | 8.0 ± 4.0 | 15.5 ± 3.0 | 74.8 ± 10.4 |
| H2 | 5.0 ± 5.0 | 22 ± 2.0 | 64.5 ± 13.0 |
| H3 | 9.5 ± 3.0 | 25 ± 2.0 | 63 ± 6.0 |
| H4 | 18.0 ± 18.0 | 23 ± 4.0 | 60.5 ± 5.0 |
| H5 | 3.0 ± 3.0 | 22 ± 2.0 | 57 ± 2.0 |
| H6 | 5.5 ± 3.0 | 16 ± 2.0 | 57 ± 12.0 |
| H7 | 3.0 ± 3.0 | 22 ± 4.0 | 44.5 ± 2.0 |
| H8 | 29 ± 18.0 | 21.5 ± 4.0 | 42 ± 8.0 |
| H9 | 2.0 ± 2.0 | 28 ± 2.0 | 40.1 ± 9.8 |
| H10 | 39.2 ± 5.6 | 25 ± 2.0 | 35 ± 2.0 |
| H11 | 48 ± 8.0 | 16 ± 2.0 | 35 ± 4.0 |
| H12 | 47 ± 8.0 | 20.5 ± 3.0 | 31.5 ± 3.0 |
| H13 | 45.2 ± 5.6 | 23 ± 2.0 | 31 ± 2.0 |
| H14 | 52.5 ± 5.0 | 25 ± 2.0 | 20.5 ± 3.0 |
| H15 | 51.7 ± 4.6 | 25 ± 2.0 | 20.5 ± 3.0 |
| H16 | 70.7 ± 4.6 | 16 ± 2.0 | 13 ± 2.0 |
| H17 | 66.7 ± 6.6 | 21 ± 2.0 | 11 ± 2.0 |
| | Fe | Cr | Ni |
| I1 | 8.0 ± 3.0 | 15.5 ± 2.3 | 74.8 ± 7.8 |
| I2 | 3.8 ± 3.8 | 22 ± 1.5 | 64.5 ± 9.8 |
| I3 | 9.5 ± 2.3 | 25 ± 1.5 | 63 ± 4.5 |
| I4 | 13.5 ± 13.5 | 23 ± 3.0 | 60.5 ± 3.8 |
| I5 | 2.3 ± 2.3 | 22 ± 1.5 | 57 ± 1.5 |
| I6 | 5.5 ± 2.3 | 16 ± 1.5 | 57 ± 9.0 |
| I7 | 2.3 ± 2.3 | 22 ± 3.0 | 44.5 ± 1.5 |
| I8 | 29 ± 13.5 | 21.5 ± 3.0 | 42 ± 6.0 |
| I9 | 1.5 ± 1.5 | 28 ± 1.5 | 40.1 ± 7.4 |
| I10 | 39.2 ± 4.2 | 25 ± 1.5 | 35 ± 1.5 |
| I11 | 48 ± 6.0 | 16 ± 1.5 | 35 ± 3.0 |
| I12 | 47 ± 6.0 | 20.5 ± 2.3 | 31.5 ± 2.3 |
| I13 | 45.2 ± 4.2 | 23 ± 1.5 | 31 ± 1.5 |
| I14 | 52.5 ± 3.8 | 25 ± 1.5 | 20.5 ± 2.3 |
| I15 | 51.7 ± 3.5 | 25 ± 1.5 | 20.5 ± 2.3 |
| I16 | 70.7 ± 3.5 | 16 ± 1.5 | 13 ± 1.5 |
| I17 | 66.7 ± 5.0 | 21 ± 1.5 | 11 ± 1.5 |
| | Fe | Cr | Ni |
| J1 | 8.0 ± 2.0 | 15.5 ± 1.5 | 74.8 ± 5.2 |
| J2 | 2.5 ± 2.5 | 22 ± 1.0 | 64.5 ± 6.5 |
| J3 | 9.5 ± 1.5 | 25 ± 1.0 | 63 ± 3.0 |
| J4 | 9.0 ± 9.0 | 23 ± 2.0 | 60.5 ± 2.5 |
| J5 | 1.5 ± 1.5 | 22 ± 1.0 | 57 ± 1.0 |
| J6 | 5.5 ± 1.5 | 16 ± 1.0 | 57 ± 6.0 |
| J7 | 1.5 ± 1.5 | 22 ± 2.0 | 44.5 ± 1.0 |
| J8 | 29 ± 9.0 | 21.5 ± 2.0 | 42 ± 4.0 |
| J9 | 1.0 ± 1.0 | 28 ± 1.0 | 40.1 ± 4.9 |
| J10 | 39.2 ± 2.8 | 25 ± 1.0 | 35 ± 1.0 |
| J11 | 48 ± 4.0 | 16 ± 1.0 | 35 ± 2.0 |
| J12 | 47 ± 4.0 | 20.5 ± 1.5 | 31.5 ± 1.5 |
| J13 | 45.2 ± 2.8 | 23 ± 1.0 | 31 ± 1.0 |
| J14 | 52.5 ± 2.5 | 25 ± 1.0 | 20.5 ± 1.5 |
| J15 | 51.7 ± 2.3 | 25 ± 1.0 | 20.5 ± 1.5 |
| J16 | 70.7 ± 2.3 | 16 ± 1.0 | 13 ± 1.0 |
| J17 | 66.7 ± 3.3 | 21 ± 1.0 | 11 ± 1.0 |

Preferably, the metal alloy is selected from the group consisting of metal alloys K1 to K12, L1 to L17, M1 to M17, N1 to N17, or O1 to O17, which each contain, based on the total weight of the metal alloy, the following content of chromium, nickel and optionally cobalt in % by weight, where further constituents not listed in the tables may be present in each case:

| | Cr | Ni | Co |
|---|---|---|---|
| K1 | 15.5 ± 4.5 | 74.8 ± 15.6 | 3.0 ± 3.0 |
| K2 | 22 ± 3.0 | 64.5 ± 19.5 | 1.5 ± 1.5 |
| K3 | 25 ± 3.0 | 63 ± 9.0 | 0.4 ± 0.4 |
| K4 | 23 ± 6.0 | 60.5 ± 7.5 | 0.4 ± 0.4 |
| K5 | 22 ± 3.0 | 57 ± 3.0 | 7.5 ± 7.5 |
| K6 | 16 ± 3.0 | 57 ± 18.0 | 4.5 ± 4.5 |
| K7 | 22 ± 6.0 | 44.5 ± 3.0 | 12.5 ± 7.5 |
| K8 | 21.5 ± 6.0 | 42 ± 12.0 | 1.5 ± 1.5 |
| K9 | 28 ± 3.0 | 40.1 ± 14.7 | 29 ± 3.0 |
| K10 | 25 ± 3.0 | 35 ± 3.0 | 0.4 ± 0.4 |
| K11 | 16 ± 3.0 | 35 ± 6.0 | 0.4 ± 0.4 |
| K12 | 20.5 ± 4.5 | 31.5 ± 4.5 | 0.4 ± 0.4 |
| K13 | 23 ± 3.0 | 31 ± 3.0 | 0.4 ± 0.4 |
| K14 | 25 ± 3.0 | 20.5 ± 4.5 | 0.4 ± 0.4 |
| K15 | 25 ± 3.0 | 20.5 ± 4.5 | 0.4 ± 0.4 |
| K16 | 16 ± 3.0 | 13 ± 3.0 | 0.4 ± 0.4 |
| K17 | 21 ± 3.0 | 11 ± 3.0 | 0.4 ± 0.4 |
| | Cr | Ni | Co |
| L1 | 15.5 ± 3.8 | 74.8 ± 13.0 | 2.5 ± 2.5 |
| L2 | 22 ± 2.5 | 64.5 ± 16.3 | 1.3 ± 1.3 |
| L3 | 25 ± 2.5 | 63 ± 7.5 | 0.3 ± 0.3 |
| L4 | 23 ± 5.0 | 60.5 ± 6.3 | 0.3 ± 0.3 |
| L5 | 22 ± 2.5 | 57 ± 2.5 | 6.3 ± 6.3 |
| L6 | 16 ± 2.5 | 57 ± 15.0 | 3.8 ± 3.8 |
| L7 | 22 ± 5.0 | 44.5 ± 2.5 | 12.5 ± 6.3 |
| L8 | 21.5 ± 5.0 | 42 ± 10.0 | 1.3 ± 1.3 |
| L9 | 28 ± 2.5 | 40.1 ± 12.3 | 29 ± 2.5 |
| L10 | 25 ± 2.5 | 35 ± 2.5 | 0.3 ± 0.3 |
| L11 | 16 ± 2.5 | 35 ± 5.0 | 0.3 ± 0.3 |
| L12 | 20.5 ± 3.8 | 31.5 ± 3.8 | 0.3 ± 0.3 |
| L13 | 23 ± 2.5 | 31 ± 2.5 | 0.3 ± 0.3 |
| L14 | 25 ± 2.5 | 20.5 ± 3.8 | 0.3 ± 0.3 |
| L15 | 25 ± 2.5 | 20.5 ± 3.8 | 0.3 ± 0.3 |
| L16 | 16 ± 2.5 | 13 ± 2.5 | 0.3 ± 0.3 |
| L17 | 21 ± 2.5 | 112.5 | 0.3 ± 0.3 |
| | Cr | Ni | Co |
| M1 | 15.5 ± 3.0 | 74.8 ± 10.4 | 2.0 ± 2.0 |
| M2 | 22 ± 2.0 | 64.5 ± 13.0 | 1.0 ± 1.0 |
| M3 | 25 ± 2.0 | 63 ± 6.0 | 0.2 ± 0.2 |
| M4 | 23 ± 4.0 | 60.5 ± 5.0 | 0.2 ± 0.2 |
| M5 | 22 ± 2.0 | 57 ± 2.0 | 5.0 ± 5.0 |
| M6 | 16 ± 2.0 | 57 ± 12.0 | 3.0 ± 3.0 |
| M7 | 22 ± 4.0 | 44.5 ± 2.0 | 12.5 ± 5.0 |
| M8 | 21.5 ± 4.0 | 42 ± 8.0 | 1.0 ± 1.0 |
| M9 | 28 ± 2.0 | 40.1 ± 9.8 | 29 ± 2.0 |
| M10 | 25 ± 2.0 | 35 ± 2.0 | 0.2 ± 0.2 |
| M11 | 16 ± 2.0 | 35 ± 4.0 | 0.2 ± 0.2 |
| M12 | 20.5 ± 3.0 | 31.5 ± 3.0 | 0.2 ± 0.2 |
| M13 | 23 ± 2.0 | 31 ± 2.0 | 0.2 ± 0.2 |
| M14 | 25 ± 2.0 | 20.5 ± 3.0 | 0.2 ± 0.2 |
| M15 | 25 ± 2.0 | 20.5 ± 3.0 | 0.2 ± 0.2 |
| M16 | 16 ± 2.0 | 13 ± 2.0 | 0.2 ± 0.2 |
| M17 | 21 ± 2.0 | 11 ± 2.0 | 0.2 ± 0.2 |
| | Cr | Ni | Co |
| N1 | 15.5 ± 2.3 | 74.8 ± 7.8 | 1.5 ± 1.5 |
| N2 | 22 ± 1.5 | 64.5 ± 9.8 | 0.8 ± 0.8 |
| N3 | 25 ± 1.5 | 63 ± 4.5 | 0.2 ± 0.2 |
| N4 | 23 ± 3.0 | 60.5 ± 3.8 | 0.2 ± 0.2 |
| N5 | 22 ± 1.5 | 57 ± 1.5 | 3.8 ± 3.8 |
| N6 | 16 ± 1.5 | 57 ± 9.0 | 2.3 ± 2.3 |
| N7 | 22 ± 3.0 | 44.5 ± 1.5 | 12.5 ± 3.8 |
| N8 | 21.5 ± 3.0 | 42 ± 6.0 | 0.8 ± 0.8 |
| N9 | 28 ± 1.5 | 40.1 ± 7.4 | 29 ± 1.5 |
| N10 | 25 ± 1.5 | 35 ± 1.5 | 0.2 ± 0.2 |
| N11 | 16 ± 1.5 | 35 ± 3.0 | 0.2 ± 0.2 |
| N12 | 20.5 ± 2.3 | 31.5 ± 2.3 | 0.2 ± 0.2 |
| N13 | 23 ± 1.5 | 31 ± 1.5 | 0.2 ± 0.2 |
| N14 | 25 ± 1.5 | 20.5 ± 2.3 | 0.2 ± 0.2 |
| N15 | 25 ± 1.5 | 20.5 ± 2.3 | 0.2 ± 0.2 |
| N16 | 16 ± 1.5 | 13 ± 1.5 | 0.2 ± 0.2 |
| N17 | 21 ± 1.5 | 11 ± 1.5 | 0.2 ± 0.2 |
| | Cr | Ni | Co |
| O1 | 15.5 ± 1.5 | 74.8 ± 5.2 | 1.0 ± 1.0 |
| O2 | 22 ± 1.0 | 64.5 ± 6.5 | 0.5 ± 0.5 |
| O3 | 25 ± 1.0 | 63 ± 3.0 | 0.1 ± 0.1 |
| O4 | 23 ± 2.0 | 60.5 ± 2.5 | 0.1 ± 0.1 |
| O5 | 22 ± 1.0 | 57 ± 1.0 | 2.5 ± 2.5 |
| O6 | 16 ± 1.0 | 57 ± 6.0 | 1.5 ± 1.5 |
| O7 | 22 ± 2.0 | 44.5 ± 1.0 | 12.5 ± 2.5 |
| O8 | 21.5 ± 2.0 | 42 ± 4.0 | 0.5 ± 0.5 |
| O9 | 28 ± 1.0 | 40.1 ± 4.9 | 29 ± 1.0 |
| O10 | 25 ± 1.0 | 35 ± 1.0 | 0.1 ± 0.1 |
| O11 | 16 ± 1.0 | 35 ± 2.0 | 0.1 ± 0.1 |
| O12 | 20.5 ± 1.5 | 31.5 ± 1.5 | 0.1 ± 0.1 |
| O13 | 23 ± 1.0 | 31 ± 1.0 | 0.1 ± 0.1 |
| O14 | 25 ± 1.0 | 20.5 ± 1.5 | 0.1 ± 0.1 |
| O15 | 25 ± 1.0 | 20.5 ± 1.5 | 0.1 ± 0.1 |
| O16 | 16 ± 1.0 | 13 ± 1.0 | 0.1 ± 0.1 |
| O17 | 21 ± 1.0 | 11 ± 1.0 | 0.1 ± 0.1 |

Preferably, the metal alloy is selected from the group consisting of metal alloys P1 to P12, Q1 to Q17, R1 to R17, S1 to S17, or T1 to T17, which each contain, based on the total weight of the metal alloy, the following content of optionally iron, chromium, nickel and optionally cobalt in % by weight, where further constituents not listed in the tables may be present in each case:

| | Fe | Cr | Ni | Co |
|---|---|---|---|---|
| P1 | 8.0 ± 6.0 | 15.5 ± 4.5 | 74.8 ± 15.6 | 3.0 ± 3.0 |
| P2 | 7.5 ± 7.5 | 22 ± 3.0 | 64.5 ± 19.5 | 1.5 ± 1.5 |
| P3 | 9.5 ± 4.5 | 25 ± 3.0 | 63 ± 9.0 | 0.4 ± 0.4 |
| P4 | 27.0 ± 27.0 | 23 ± 6.0 | 60.5 ± 7.5 | 0.4 ± 0.4 |
| P5 | 4.5 ± 4.5 | 22 ± 3.0 | 57 ± 3.0 | 7.5 ± 7.5 |
| P6 | 5.5 ± 4.5 | 16 ± 3.0 | 57 ± 18.0 | 4.5 ± 4.5 |
| P7 | 4.5 ± 4.5 | 22 ± 6.0 | 44.5 ± 3.0 | 12.5 ± 7.5 |
| P8 | 29 ± 27.0 | 21.5 ± 6.0 | 42 ± 12.0 | 1.5 ± 1.5 |
| P9 | 3.0 ± 3.0 | 28 ± 3.0 | 40.1 ± 14.7 | 29 ± 3.0 |
| P10 | 39.2 ± 8.4 | 25 ± 3.0 | 35 ± 3.0 | 0.4 ± 0.4 |
| P11 | 48 ± 12.0 | 16 ± 3.0 | 35 ± 6.0 | 0.4 ± 0.4 |
| P12 | 47 ± 12.0 | 20.5 ± 4.5 | 31.5 ± 4.5 | 0.4 ± 0.4 |
| P13 | 45.2 ± 8.4 | 23 ± 3.0 | 31 ± 3.0 | 0.4 ± 0.4 |
| P14 | 52.5 ± 7.5 | 25 ± 3.0 | 20.5 ± 4.5 | 0.4 ± 0.4 |
| P15 | 51.7 ± 6.9 | 25 ± 3.0 | 20.5 ± 4.5 | 0.4 ± 0.4 |
| P16 | 70.7 ± 6.9 | 16 ± 3.0 | 13 ± 3.0 | 0.4 ± 0.4 |
| P17 | 66.7 ± 9.9 | 21 ± 3.0 | 11 ± 3.0 | 0.4 ± 0.4 |
| Q1 | 8.0 ± 5.0 | 15.5 ± 3.8 | 74.8 ± 13.0 | 2.5 ± 2.5 |
| Q2 | 6.3 ± 6.3 | 22 ± 2.5 | 64.5 ± 16.3 | 1.3 ± 1.3 |
| Q3 | 9.5 ± 3.8 | 25 ± 2.5 | 63 ± 7.5 | 0.3 ± 0.3 |
| Q4 | 22.5 ± 22.5 | 23 ± 5.0 | 60.5 ± 6.3 | 0.3 ± 0.3 |
| Q5 | 3.8 ± 3.8 | 22 ± 2.5 | 57 ± 2.5 | 6.3 ± 6.3 |
| Q6 | 5.5 ± 3.8 | 16 ± 2.5 | 57 ± 15.0 | 3.8 ± 3.8 |
| Q7 | 3.8 ± 3.8 | 22 ± 5.0 | 44.5 ± 2.5 | 12.5 ± 6.3 |
| Q8 | 29 ± 22.5 | 21.5 ± 5.0 | 42 ± 10.0 | 1.3 ± 1.3 |
| Q9 | 2.5 ± 2.5 | 28 ± 2.5 | 40.1 ± 12.3 | 29 ± 2.5 |
| Q10 | 39.2 ± 7.0 | 25 ± 2.5 | 35 ± 2.5 | 0.3 ± 0.3 |
| Q11 | 48 ± 10.0 | 16 ± 2.5 | 35 ± 5.0 | 0.3 ± 0.3 |
| Q12 | 47 ± 10.0 | 20.5 ± 3.8 | 31.5 ± 3.8 | 0.3 ± 0.3 |
| Q13 | 45.2 ± 7.0 | 23 ± 2.5 | 31 ± 2.5 | 0.3 ± 0.3 |
| Q14 | 52.5 ± 6.3 | 25 ± 2.5 | 20.5 ± 3.8 | 0.3 ± 0.3 |
| Q15 | 51.7 ± 5.8 | 25 ± 2.5 | 20.5 ± 3.8 | 0.3 ± 0.3 |
| Q16 | 70.7 ± 5.8 | 16 ± 2.5 | 13 ± 2.5 | 0.3 ± 0.3 |
| Q17 | 66.7 ± 8.3 | 21 ± 2.5 | 112.5 | 0.3 ± 0.3 |
| R1 | 8.0 ± 4.0 | 15.5 ± 3.0 | 74.8 ± 10.4 | 2.0 ± 2.0 |
| R2 | 5.0 ± 5.0 | 22 ± 2.0 | 64.5 ± 13.0 | 1.0 ± 1.0 |
| R3 | 9.5 ± 3.0 | 25 ± 2.0 | 63 ± 6.0 | 0.2 ± 0.2 |
| R4 | 18.0 ± 18.0 | 23 ± 4.0 | 60.5 ± 5.0 | 0.2 ± 0.2 |
| R5 | 3.0 ± 3.0 | 22 ± 2.0 | 57 ± 2.0 | 5.0 ± 5.0 |
| R6 | 5.5 ± 3.0 | 16 ± 2.0 | 57 ± 12.0 | 3.0 ± 3.0 |
| R7 | 3.0 ± 3.0 | 22 ± 4.0 | 44.5 ± 2.0 | 12.5 ± 5.0 |
| R8 | 29 ± 18.0 | 21.5 ± 4.0 | 42 ± 8.0 | 1.0 ± 1.0 |
| R9 | 2.0 ± 2.0 | 28 ± 2.0 | 40.1 ± 9.8 | 29 ± 2.0 |
| R10 | 39.2 ± 5.6 | 25 ± 2.0 | 35 ± 2.0 | 0.2 ± 0.2 |
| R11 | 48 ± 8.0 | 16 ± 2.0 | 35 ± 4.0 | 0.2 ± 0.2 |
| R12 | 47 ± 8.0 | 20.5 ± 3.0 | 31.5 ± 3.0 | 0.2 ± 0.2 |
| R13 | 45.2 ± 5.6 | 23 ± 2.0 | 31 ± 2.0 | 0.2 ± 0.2 |
| R14 | 52.5 ± 5.0 | 25 ± 2.0 | 20.5 ± 3.0 | 0.2 ± 0.2 |
| R15 | 51.7 ± 4.6 | 25 ± 2.0 | 20.5 ± 3.0 | 0.2 ± 0.2 |
| R16 | 70.7 ± 4.6 | 16 ± 2.0 | 13 ± 2.0 | 0.2 ± 0.2 |
| R17 | 66.7 ± 6.6 | 21 ± 2.0 | 11 ± 2.0 | 0.2 ± 0.2 |
| S1 | 8.0 ± 3.0 | 15.5 ± 2.3 | 74.8 ± 7.8 | 1.5 ± 1.5 |
| S2 | 3.8 ± 3.8 | 22 ± 1.5 | 64.5 ± 9.8 | 0.8 ± 0.8 |
| S3 | 9.5 ± 2.3 | 25 ± 1.5 | 63 ± 4.5 | 0.2 ± 0.2 |
| S4 | 13.5 ± 13.5 | 23 ± 3.0 | 60.5 ± 3.8 | 0.2 ± 0.2 |
| S5 | 2.3 ± 2.3 | 22 ± 1.5 | 57 ± 1.5 | 3.8 ± 3.8 |
| S6 | 5.5 ± 2.3 | 16 ± 1.5 | 57 ± 9.0 | 2.3 ± 2.3 |
| S7 | 2.3 ± 2.3 | 22 ± 3.0 | 44.5 ± 1.5 | 12.5 ± 3.8 |
| S8 | 29 ± 13.5 | 21.5 ± 3.0 | 42 ± 6.0 | 0.8 ± 0.8 |
| S9 | 1.5 ± 1.5 | 28 ± 1.5 | 40.1 ± 7.4 | 29 ± 1.5 |
| S10 | 39.2 ± 4.2 | 25 ± 1.5 | 35 ± 1.5 | 0.2 ± 0.2 |
| S11 | 48 ± 6.0 | 16 ± 1.5 | 35 ± 3.0 | 0.2 ± 0.2 |
| S12 | 47 ± 6.0 | 20.5 ± 2.3 | 31.5 ± 2.3 | 0.2 ± 0.2 |
| S13 | 45.2 ± 4.2 | 23 ± 1.5 | 31 ± 1.5 | 0.2 ± 0.2 |
| S14 | 52.5 ± 3.8 | 25 ± 1.5 | 20.5 ± 2.3 | 0.2 ± 0.2 |
| S15 | 51.7 ± 3.5 | 25 ± 1.5 | 20.5 ± 2.3 | 0.2 ± 0.2 |
| S16 | 70.7 ± 3.5 | 16 ± 1.5 | 13 ± 1.5 | 0.2 ± 0.2 |
| S17 | 66.7 ± 5.0 | 21 ± 1.5 | 11 ± 1.5 | 0.2 ± 0.2 |
| T1 | 8.0 ± 2.0 | 15.5 ± 1.5 | 74.8 ± 5.2 | 1.0 ± 1.0 |
| T2 | 2.5 ± 2.5 | 22 ± 1.0 | 64.5 ± 6.5 | 0.5 ± 0.5 |
| T3 | 9.5 ± 1.5 | 25 ± 1.0 | 63 ± 3.0 | 0.1 ± 0.1 |
| T4 | 9.0 ± 9.0 | 23 ± 2.0 | 60.5 ± 2.5 | 0.1 ± 0.1 |
| T5 | 1.5 ± 1.5 | 22 ± 1.0 | 57 ± 1.0 | 2.5 ± 2.5 |
| T6 | 5.5 ± 1.5 | 16 ± 1.0 | 57 ± 6.0 | 1.5 ± 1.5 |
| T7 | 1.5 ± 1.5 | 22 ± 2.0 | 44.5 ± 1.0 | 12.5 ± 2.5 |
| T8 | 29 ± 9.0 | 21.5 ± 2.0 | 42 ± 4.0 | 0.5 ± 0.5 |
| T9 | 1.0 ± 1.0 | 28 ± 1.0 | 40.1 ± 4.9 | 29 ± 1.0 |
| T10 | 39.2 ± 2.8 | 25 ± 1.0 | 35 ± 1.0 | 0.1 ± 0.1 |
| T11 | 48 ± 4.0 | 16 ± 1.0 | 35 ± 2.0 | 0.1 ± 0.1 |
| T12 | 47 ± 4.0 | 20.5 ± 1.5 | 31.5 ± 1.5 | 0.1 ± 0.1 |
| T13 | 45.2 ± 2.8 | 23 ± 1.0 | 31 ± 1.0 | 0.1 ± 0.1 |
| T14 | 52.5 ± 2.5 | 25 ± 1.0 | 20.5 ± 1.5 | 0.1 ± 0.1 |
| T15 | 51.7 ± 2.3 | 25 ± 1.0 | 20.5 ± 1.5 | 0.1 ± 0.1 |
| T16 | 70.7 ± 2.3 | 16 ± 1.0 | 13 ± 1.0 | 0.1 ± 0.1 |
| T17 | 66.7 ± 3.3 | 21 ± 1.0 | 11 ± 1.0 | 0.1 ± 0.1 |

Preferably, the metal alloy is selected from the group consisting of metal alloys U1 to U12, V1 to V17, W1 to W17, X1 to X17, or Y1 to Y17, which each contain, based on the total weight of the metal alloy, the following content of optionally iron, chromium, nickel, optionally cobalt, optionally aluminum and optionally titanium in % by weight, where further constituents not listed in the tables may be present in each case:

| [% by wt.] | Fe | Cr | Ni | Co | Al | Ti |
|---|---|---|---|---|---|---|
| U1 | 8.0 ± 6.0 | 15.5 ± 4.5 | 74.8 ± 15.6 | 3.0 ± 3.0 | 0.6 ± 0.6 | 0.6 ± 0.6 |
| U2 | 7.5 ± 7.5 | 22 ± 3.0 | 64.5 ± 19.5 | 1.5 ± 1.5 | 0.6 ± 0.6 | 0.6 ± 0.6 |
| U3 | 9.5 ± 4.5 | 25 ± 3.0 | 63 ± 9.0 | 0.4 ± 0.4 | 3.6 ± 3.6 | 0.3 ± 0.3 |
| U4 | 27.0 ± 27.0 | 23 ± 6.0 | 60.5 ± 7.5 | 0.4 ± 0.4 | 2.7 ± 2.7 | 0.9 ± 0.9 |
| U5 | 4.5 ± 4.5 | 22 ± 3.0 | 57 ± 3.0 | 7.5 ± 7.5 | 0.6 ± 0.6 | 0.6 ± 0.6 |
| U6 | 5.5 ± 4.5 | 16 ± 3.0 | 57 ± 18.0 | 4.5 ± 4.5 | 0.4 ± 0.4 | 0.4 ± 0.4 |
| U7 | 4.5 ± 4.5 | 22 ± 6.0 | 44.5 ± 3.0 | 12.5 ± 7.5 | 2.4 ± 2.4 | 0.9 ± 0.9 |
| U8 | 29 ± 27.0 | 21.5 ± 6.0 | 42 ± 12.0 | 1.5 ± 1.5 | 0.3 ± 0.3 | 1.8 ± 1.8 |
| U9 | 3.0 ± 3.0 | 28 ± 3.0 | 40.1 ± 14.7 | 29 ± 3.0 | 0.6 ± 0.6 | 0.9 ± 0.9 |
| U10 | 39.2 ± 8.4 | 25 ± 3.0 | 35 ± 3.0 | 0.4 ± 0.4 | 0.4 ± 0.4 | 0.4 ± 0.4 |
| U11 | 48 ± 12.0 | 16 ± 3.0 | 35 ± 6.0 | 0.4 ± 0.4 | 0.4 ± 0.4 | 0.4 ± 0.4 |
| U12 | 47 ± 12.0 | 20.5 ± 4.5 | 31.5 ± 4.5 | 0.4 ± 0.4 | 0.9 ± 0.9 | 0.9 ± 0.9 |
| U13 | 45.2 ± 8.4 | 23 ± 3.0 | 31 ± 3.0 | 0.4 ± 0.4 | 0.6 ± 0.6 | 1.5 ± 1.5 |
| U14 | 52.5 ± 7.5 | 25 ± 3.0 | 20.5 ± 4.5 | 0.4 ± 0.4 | 0.4 ± 0.4 | 0.4 ± 0.4 |
| U15 | 51.7 ± 6.9 | 25 ± 3.0 | 20.5 ± 4.5 | 0.4 ± 0.4 | 0.4 ± 0.4 | 0.4 ± 0.4 |
| U16 | 70.7 ± 6.9 | 16 ± 3.0 | 13 ± 3.0 | 0.4 ± 0.4 | 0.4 ± 0.4 | 0.4 ± 0.4 |
| U17 | 66.7 ± 9.9 | 21 ± 3.0 | 11 ± 3.0 | 0.4 ± 0.4 | 0.4 ± 0.4 | 0.4 ± 0.4 |
| [% by wt.] | Fe | Cr | Ni | Co | Al | Ti |
| V1 | 8.0 ± 5.0 | 15.5 ± 3.8 | 74.8 ± 13.0 | 2.5 ± 2.5 | 0.5 ± 0.5 | 0.5 ± 0.5 |
| V2 | 6.3 ± 6.3 | 22 ± 2.5 | 64.5 ± 16.3 | 1.3 ± 1.3 | 0.5 ± 0.5 | 0.5 ± 0.5 |
| V3 | 9.5 ± 3.8 | 25 ± 2.5 | 63 ± 7.5 | 0.3 ± 0.3 | 3.0 ± 3.0 | 0.3 ± 0.3 |
| V4 | 22.5 ± 22.5 | 23 ± 5.0 | 60.5 ± 6.3 | 0.3 ± 0.3 | 2.3 ± 2.3 | 0.8 ± 0.8 |
| V5 | 3.8 ± 3.8 | 22 ± 2.5 | 57 ± 2.5 | 6.3 ± 6.3 | 0.5 ± 0.5 | 0.5 ± 0.5 |
| V6 | 5.5 ± 3.8 | 16 ± 2.5 | 57 ± 15.0 | 3.8 ± 3.8 | 0.3 ± 0.3 | 0.3 ± 0.3 |
| V7 | 3.8 ± 3.8 | 22 ± 5.0 | 44.5 ± 2.5 | 12.5 ± 6.3 | 2.0 ± 2.0 | 0.8 ± 0.8 |
| V8 | 29 ± 22.5 | 21.5 ± 5.0 | 42 ± 10.0 | 1.3 ± 1.3 | 0.3 ± 0.3 | 1.5 ± 1.5 |
| V9 | 2.5 ± 2.5 | 28 ± 2.5 | 40.1 ± 12.3 | 29 ± 2.5 | 0.5 ± 0.5 | 0.8 ± 0.8 |
| V10 | 39.2 ± 7.0 | 25 ± 2.5 | 35 ± 2.5 | 0.3 ± 0.3 | 0.3 ± 0.3 | 0.3 ± 0.3 |
| V11 | 48 ± 10.0 | 16 ± 2.5 | 35 ± 5.0 | 0.3 ± 0.3 | 0.3 ± 0.3 | 0.3 ± 0.3 |
| V12 | 47 ± 10.0 | 20.5 ± 3.8 | 31.5 ± 3.8 | 0.3 ± 0.3 | 0.8 ± 0.8 | 0.8 ± 0.8 |
| V13 | 45.2 ± 7.0 | 23 ± 2.5 | 31 ± 2.5 | 0.3 ± 0.3 | 0.5 ± 0.5 | 1.3 ± 1.3 |
| V14 | 52.5 ± 6.3 | 25 ± 2.5 | 20.5 ± 3.8 | 0.3 ± 0.3 | 0.3 ± 0.3 | 0.3 ± 0.3 |
| V15 | 51.7 ± 5.8 | 25 ± 2.5 | 20.5 ± 3.8 | 0.3 ± 0.3 | 0.3 ± 0.3 | 0.3 ± 0.3 |
| V16 | 70.7 ± 5.8 | 16 ± 2.5 | 13 ± 2.5 | 0.3 ± 0.3 | 0.3 ± 0.3 | 0.3 ± 0.3 |
| V17 | 66.7 ± 8.3 | 21 ± 2.5 | 112.5 | 0.3 ± 0.3 | 0.3 ± 0.3 | 0.3 ± 0.3 |
| [% by wt.] | Fe | Cr | Ni | Co | Al | Ti |
| W1 | 8.0 ± 4.0 | 15.5 ± 3.0 | 74.8 ± 10.4 | 2.0 ± 2.0 | 0.4 ± 0.4 | 0.4 ± 0.4 |
| W2 | 5.0 ± 5.0 | 22 ± 2.0 | 64.5 ± 13.0 | 1.0 ± 1.0 | 0.4 ± 0.4 | 0.4 ± 0.4 |
| W3 | 9.5 ± 3.0 | 25 ± 2.0 | 63 ± 6.0 | 0.2 ± 0.2 | 2.4 ± 2.4 | 0.2 ± 0.2 |
| W4 | 18.0 ± 18.0 | 23 ± 4.0 | 60.5 ± 5.0 | 0.2 ± 0.2 | 1.8 ± 1.8 | 0.6 ± 0.6 |
| W5 | 3.0 ± 3.0 | 22 ± 2.0 | 57 ± 2.0 | 5.0 ± 5.0 | 0.4 ± 0.4 | 0.4 ± 0.4 |
| W6 | 5.5 ± 3.0 | 16 ± 2.0 | 57 ± 12.0 | 3.0 ± 3.0 | 0.2 ± 0.2 | 0.2 ± 0.2 |
| W7 | 3.0 ± 3.0 | 22 ± 4.0 | 44.5 ± 2.0 | 12.5 ± 5.0 | 1.6 ± 1.6 | 0.6 ± 0.6 |
| W8 | 29 ± 18.0 | 21.5 ± 4.0 | 42 ± 8.0 | 1.0 ± 1.0 | 0.2 ± 0.2 | 1.2 ± 1.2 |
| W9 | 2.0 ± 2.0 | 28 ± 2.0 | 40.1 ± 9.8 | 29 ± 2.0 | 0.4 ± 0.4 | 0.6 ± 0.6 |
| W10 | 39.2 ± 5.6 | 25 ± 2.0 | 35 ± 2.0 | 0.2 ± 0.2 | 0.2 ± 0.2 | 0.2 ± 0.2 |
| W11 | 48 ± 8.0 | 16 ± 2.0 | 35 ± 4.0 | 0.2 ± 0.2 | 0.2 ± 0.2 | 0.2 ± 0.2 |
| W12 | 47 ± 8.0 | 20.5 ± 3.0 | 31.5 ± 3.0 | 0.2 ± 0.2 | 0.6 ± 0.6 | 0.6 ± 0.6 |
| W13 | 45.2 ± 5.6 | 23 ± 2.0 | 31 ± 2.0 | 0.2 ± 0.2 | 0.4 ± 0.4 | 1.0 ± 1.0 |
| W14 | 52.5 ± 5.0 | 25 ± 2.0 | 20.5 ± 3.0 | 0.2 ± 0.2 | 0.2 ± 0.2 | 0.2 ± 0.2 |
| W15 | 51.7 ± 4.6 | 25 ± 2.0 | 20.5 ± 3.0 | 0.2 ± 0.2 | 0.2 ± 0.2 | 0.2 ± 0.2 |
| W16 | 70.7 ± 4.6 | 16 ± 2.0 | 13 ± 2.0 | 0.2 ± 0.2 | 0.2 ± 0.2 | 0.2 ± 0.2 |
| W17 | 66.7 ± 6.6 | 21 ± 2.0 | 11 ± 2.0 | 0.2 ± 0.2 | 0.2 ± 0.2 | 0.2 ± 0.2 |
| [% by wt.] | Fe | Cr | Ni | Co | Al | Ti |
| X1 | 8.0 ± 3.0 | 15.5 ± 2.3 | 74.8 ± 7.8 | 1.5 ± 1.5 | 0.3 ± 0.3 | 0.3 ± 0.3 |
| X2 | 3.8 ± 3.8 | 22 ± 1.5 | 64.5 ± 9.8 | 0.8 ± 0.8 | 0.3 ± 0.3 | 0.3 ± 0.3 |
| X3 | 9.5 ± 2.3 | 25 ± 1.5 | 63 ± 4.5 | 0.2 ± 0.2 | 1.8 ± 1.8 | 0.2 ± 0.2 |
| X4 | 13.5 ± 13.5 | 23 ± 3.0 | 60.5 ± 3.8 | 0.2 ± 0.2 | 1.4 ± 1.4 | 0.5 ± 0.5 |
| X5 | 2.3 ± 2.3 | 22 ± 1.5 | 57 ± 1.5 | 3.8 ± 3.8 | 0.3 ± 0.3 | 0.3 ± 0.3 |
| X6 | 5.5 ± 2.3 | 16 ± 1.5 | 57 ± 9.0 | 2.3 ± 2.3 | 0.2 ± 0.2 | 0.2 ± 0.2 |
| X7 | 2.3 ± 2.3 | 22 ± 3.0 | 44.5 ± 1.5 | 12.5 ± 3.8 | 1.2 ± 1.2 | 0.5 ± 0.5 |
| X8 | 29 ± 13.5 | 21.5 ± 3.0 | 42 ± 6.0 | 0.8 ± 0.8 | 0.2 ± 0.2 | 0.9 ± 0.9 |
| X9 | 1.5 ± 1.5 | 28 ± 1.5 | 40.1 ± 7.4 | 29 ± 1.5 | 0.3 ± 0.3 | 0.5 ± 0.5 |
| X10 | 39.2 ± 4.2 | 25 ± 1.5 | 35 ± 1.5 | 0.2 ± 0.2 | 0.2 ± 0.2 | 0.2 ± 0.2 |
| X11 | 48 ± 6.0 | 16 ± 1.5 | 35 ± 3.0 | 0.2 ± 0.2 | 0.2 ± 0.2 | 0.2 ± 0.2 |
| X12 | 47 ± 6.0 | 20.5 ± 2.3 | 31.5 ± 2.3 | 0.2 ± 0.2 | 0.5 ± 0.5 | 0.5 ± 0.5 |
| X13 | 45.2 ± 4.2 | 23 ± 1.5 | 31 ± 1.5 | 0.2 ± 0.2 | 0.3 ± 0.3 | 0.8 ± 0.8 |
| X14 | 52.5 ± 3.8 | 25 ± 1.5 | 20.5 ± 2.3 | 0.2 ± 0.2 | 0.2 ± 0.2 | 0.2 ± 0.2 |
| X15 | 51.7 ± 3.5 | 25 ± 1.5 | 20.5 ± 2.3 | 0.2 ± 0.2 | 0.2 ± 0.2 | 0.2 ± 0.2 |
| X16 | 70.7 ± 3.5 | 16 ± 1.5 | 13 ± 1.5 | 0.2 ± 0.2 | 0.2 ± 0.2 | 0.2 ± 0.2 |
| X17 | 66.7 ± 5.0 | 21 ± 1.5 | 11 ± 1.5 | 0.2 ± 0.2 | 0.2 ± 0.2 | 0.2 ± 0.2 |
| [% by wt.] | Fe | Cr | Ni | Co | Al | Ti |
| Y1 | 8.0 ± 2.0 | 15.5 ± 1.5 | 74.8 ± 5.2 | 1.0 ± 1.0 | 0.2 ± 0.2 | 0.2 ± 0.2 |
| Y2 | 2.5 ± 2.5 | 22 ± 1.0 | 64.5 ± 6.5 | 0.5 ± 0.5 | 0.2 ± 0.2 | 0.2 ± 0.2 |
| Y3 | 9.5 ± 1.5 | 25 ± 1.0 | 63 ± 3.0 | 0.1 ± 0.1 | 1.2 ± 1.2 | 0.1 ± 0.1 |
| Y4 | 9.0 ± 9.0 | 23 ± 2.0 | 60.5 ± 2.5 | 0.1 ± 0.1 | 0.9 ± 0.9 | 0.3 ± 0.3 |
| Y5 | 1.5 ± 1.5 | 22 ± 1.0 | 57 ± 1.0 | 2.5 ± 2.5 | 0.2 ± 0.2 | 0.2 ± 0.2 |
| Y6 | 5.5 ± 1.5 | 16 ± 1.0 | 57 ± 6.0 | 1.5 ± 1.5 | 0.1 ± 0.1 | 0.1 ± 0.1 |
| Y7 | 1.5 ± 1.5 | 22 ± 2.0 | 44.5 ± 1.0 | 12.5 ± 2.5 | 0.8 ± 0.8 | 0.3 ± 0.3 |
| Y8 | 29 ± 9.0 | 21.5 ± 2.0 | 42 ± 4.0 | 0.5 ± 0.5 | 0.1 ± 0.1 | 0.6 ± 0.6 |
| Y9 | 1.0 ± 1.0 | 28 ± 1.0 | 40.1 ± 4.9 | 29 ± 1.0 | 0.2 ± 0.2 | 0.3 ± 0.3 |
| Y10 | 39.2 ± 2.8 | 25 ± 1.0 | 35 ± 1.0 | 0.1 ± 0.1 | 0.1 ± 0.1 | 0.1 ± 0.1 |
| Y11 | 48 ± 4.0 | 16 ± 1.0 | 35 ± 2.0 | 0.1 ± 0.1 | 0.1 ± 0.1 | 0.1 ± 0.1 |
| Y12 | 47 ± 4.0 | 20.5 ± 1.5 | 31.5 ± 1.5 | 0.1 ± 0.1 | 0.3 ± 0.3 | 0.3 ± 0.3 |
| Y13 | 45.2 ± 2.8 | 23 ± 1.0 | 31 ± 1.0 | 0.1 ± 0.1 | 0.2 ± 0.2 | 0.5 ± 0.5 |
| Y14 | 52.5 ± 2.5 | 25 ± 1.0 | 20.5 ± 1.5 | 0.1 ± 0.1 | 0.1 ± 0.1 | 0.1 ± 0.1 |
| Y15 | 51.7 ± 2.3 | 25 ± 1.0 | 20.5 ± 1.5 | 0.1 ± 0.1 | 0.1 ± 0.1 | 0.1 ± 0.1 |
| Y16 | 70.7 ± 2.3 | 16 ± 1.0 | 13 ± 1.0 | 0.1 ± 0.1 | 0.1 ± 0.1 | 0.1 ± 0.1 |
| Y17 | 66.7 ± 3.3 | 21 ± 1.0 | 11 ± 1.0 | 0.1 ± 0.1 | 0.1 ± 0.1 | 0.1 ± 0.1 |

Preferably, the metal alloy of the invention is selected from the group consisting of materials according to DIN/EN X9CrNiSiNCe21-11-2, X8CrNiNb16-13, X12CrNi25-21, X10NiCrAlTi32-20, X5NiCrAlTi31-20, X12NiCrSi35-16, 35Ni25Cr1.5SiCeN, NiFe30Cr21Mo3, NiCr23Co12Mo, NiMo16Cr15Fe6W4, NiCr22W14Mo, NiCr23Fe15Al, NiCr25FeAlY, NiCr22Mo9Nb, and NiCr15Fe.

Preferably, the metal alloy of the invention is selected from the group consisting of materials of material class DIN No. 1.4820, 1.4821, 1.4822, 1.4823, 1.4824, 1.4825, 1.4826, 1.4827, 1.4828, 1.4829, 1.4830, 1.4831, 1.4832, 1.4833, 1.4834, 1.4835, 1.4836, 1.4837, 1.4838, 1.4839, 1.4840, 1.4841, 1.4842, 1.4843, 1.4844, 1.4845, 1.4846, 1.4847, 1.4848, 1.4849, 1.4850, 1.4851, 1.4852, 1.4853, 1.4854, 1.4855, 1.4856, 1.4857, 1.4858, 1.4859, 1.4860, 1.4861, 1.4862, 1.4863, 1.4864, 1.4865, 1.4866, 1.4867, 1.4868, 1.4869, 1.4870, 1.4871, 1.4872, 1.4873, 1.4874, 1.4875, 1.4876, 1.4877, 1.4878, 1.4879, 1.4880, 1.4881, 1.4882, 1.4883, 1.4884, 1.4885, and 1.4886.

Preferably, the metal alloy of the invention is selected from the group consisting of materials of material class DIN No. 1.4948, 1.4949, 1.4950, 1.4951, 1.4952, 1.4953, 1.4954, 1.4955, 1.4956, 1.4957, 1.4958, 1.4959, 1.4960, 1.4961, 1.4962, 1.4963, 1.4964, 1.4965, 1.4966, 1.4967, 1.4968, 1.4969, 1.4970, and 1.4971.

Preferably, the metal alloy of the invention is selected from the group consisting of materials of material class DIN No. 2.4630, 2.4633, 2.4650, 2.4653, 2.4654, 2.4655, 2.4656, 2.4657, 2.4658, 2.4659, 2.4660, 2.4661, 2.4662, 2.4663, 2.4664, 2.4665, 2.4666, 2.4667, 2.4668, 2.4669, 2.4670, 2.4671, 2.4672, and 2.4673.

Preferably, the metal alloy of the invention is selected from the group consisting of materials of material class DIN No. 2.4723, 2.4724, 2.4725, 2.4726, 2.4727, 2.4728, 2.4729, 2.4730, 2.4731, 2.4732, 2.4733, 2.4734, 2.4735, 2.4736, 2.4737, 2.4738, 2.4739, 2.4740, 2.4741, 2.4742, and 2.4743.

Preferably, the metal alloy of the invention is selected from the group consisting of materials of material class DIN No. 2.4806, 2.4807, 2.4808, 2.4809, 2.4810, 2.4811, 2.4812, 2.4813, 2.4814, 2.4815, 2.4816, 2.4817, 2.4818, 2.4819, 2.4820, 2.4821, 2.4822, 2.4823, 2.4824, 2.4825, 2.4826, 2.4827, 2.4828, 2.4829, 2.4830, 2.4831, 2.4832, 2.4833, 2.4834, 2.4835, 2.4836, 2.4837, 2.4838, 2.4839, 2.4840, 2.4841, 2.4842, 2.4843, 2.4844, 2.4845, 2.4846, 2.4847, 2.4848, 2.4849, 2.4850, 2.4851, 2.4852, 2.4853, 2.4854, 2.4855, 2.4856, 2.4857, 2.4858, 2.4859, 2.4860, 2.4861, 2.4862, 2.4863, 2.4864, 2.4865, 2.4866, 2.4867, 2.4868, and 2.4879.

Preferably, the metal alloy comes into direct contact with gaseous NH₃.

Preferably, the metal alloy does not come into direct contact with NH₃ in a supercritical state.

A further aspect of the invention relates to a method of catalytic decomposition of NH₃ to N₂ and H₂ in a plant of the invention as described above, wherein the NH₃ is introduced into the reactor at a temperature of at least 500° C., more preferably at least 530° C., even more preferably at least 560° C., most preferably at least 590° C., and in particular at least 620° C.

Preferably, the component is subjected to a temperature of at least 500° C., more preferably at least 530° C., even more preferably at least 560° C., most preferably at least 590° C., and in particular at least 620° C. Preferably, the component is subjected to a temperature of at least 650° C., more preferably at least 680° C., even more preferably at least 710° C., most preferably at least 740° C., and in particular at least 770° C. Preferably, the component is subjected to a temperature of at least 800° C., more preferably at least 830° C., even more preferably at least 860° C., most preferably at least 890° C., and in particular at least 920° C.

The NH₃ is preferably in the gaseous state in the reactor.

The NH₃ is preferably not in a supercritical state in the reactor.

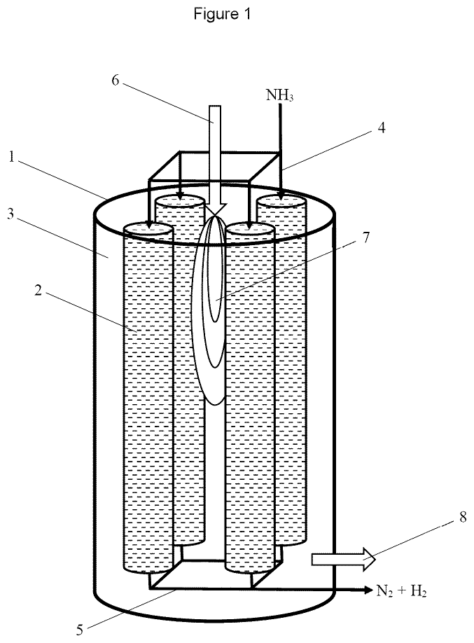

FIG. 1 is a schematic illustration of a preferred embodiment of an inventive reactor 1 which comprises, by way of example, four tubular reaction chambers 2 each containing NH₃ decomposition catalyst. The reactor 1 forms, in its interior, a combustion chamber 3 in which the four tubular reaction chambers 2 are arranged in parallel as a bundle. Via a feed system 4, NH₃ (reactant gas) is fed into reactor 1 and into each of the reaction chambers 2, in order to react therein over the NH₃ decomposition catalyst to give product gas. The product gas comprising N₂ and H₂ is discharged from the reaction chambers 2 and reactor 1 via discharge system 5. In the parallel direction of flow to the NH₃, combustion gas is directed via feed 6 into the combustion chamber 3, where it is burnt to form flame 7. The heat of combustion formed in the combustion flows from the inside of the combustion chamber 3 through the wall of the reaction chambers 2 to the NH₃ decomposition catalyst. The flue gas formed in the combustion is discharged from combustion chamber 3 and reactor 1 via outlet 8.

### LIST OF REFERENCE SYMBOLS

1—reactor
2—reaction chamber
3—combustion chamber
4—supply line system for NH₃
discharge system for product gas
6—feed for combustion gas
7—flame
8—outlet for flue gas

1-48. (canceled)

49. A plant for production of H₂ by catalytic decomposition of NH₃ to N₂ and H₂, comprising:
a reactor containing an NH₃ decomposition catalyst; and
at least one component formed at least partly from a metal alloy;
wherein the metal alloy comes into direct contact with the NH₃ and/or N₂ at least in one region of its surface in the course of operation of the reactor;
wherein the metal alloy contains nickel and chromium with a total nickel and chromium content of at least 15% by weight, based on the total weight of the metal alloy.

50. The plant as claimed in claim 49, wherein a nickel content of the metal alloy is at least 5.0% and at most 60% by weight based on the total weight of the metal alloy.

51. The plant as claimed in claim 49, wherein the metal alloy contains cobalt and a cobalt content of the metal alloy is at least 4.0% by weight based on the total weight of the metal alloy.

52. The plant as claimed in claim 49, wherein a chromium content of the metal alloy is at least 12% and at most 40% by weight based on the total weight of the metal alloy.

53. The plant as claimed in claim 49, wherein the metal alloy contains molybdenum and a molybdenum content of the metal alloy is at least 1.0% by weight based on the total weight of the metal alloy.

54. The plant as claimed in claim 49, wherein the metal alloy contains tungsten and a tungsten content of the metal alloy is at least 1.0% by weight based on the total weight of the metal alloy.

55. The plant as claimed in claim 49, wherein, with respect to the metal alloy, {[(molybdenum content)+0.5×(tungsten content)]} is less than 1.5% by weight based on the total weight of the metal alloy.

56. The plant as claimed in claim 49, wherein, with respect to the metal alloy, {[(molybdenum content)+0.5×(tungsten content)]} is at most 1.4% by weight based on the total weight of the metal alloy.

57. The plant as claimed in claim 49, wherein, with respect to the metal alloy, {[(molybdenum content)+0.5×(tungsten content)]} is more than 8.5% by weight based on the total weight of the metal alloy.

58. The plant as claimed in claim 49, wherein, with respect to the metal alloy, {[(molybdenum content)+0.5×(tungsten content)]} is at least 8.6% by weight based on the total weight of the metal alloy.

59. The plant as claimed in claim 49, wherein, with respect to the metal alloy, (1.8×chromium/{[(molybdenum content)+0.5×(tungsten content)]}) is less than 3.0% by weight based on the total weight of the metal alloy.

60. The plant as claimed in claim 49, wherein, with respect to the metal alloy, (1.8×chromium/{[(molybdenum content)+0.5×(tungsten content)]}) is at most 2.9% by weight based on the total weight of the metal alloy.

61. The plant as claimed in claim 49, wherein, with respect to the metal alloy, (1.8×chromium/{[(molybdenum content)+0.5×(tungsten content)]}) is more than 10% by weight based on the total weight of the metal alloy.

62. The plant as claimed in claim 49, wherein, with respect to the metal alloy, (1.8×chromium/{[(molybdenum content)+0.5×(tungsten content)]}) is at least 30% by weight based on the total weight of the metal alloy.

63. The plant as claimed in claim 49, wherein the metal alloy contains aluminum and/or titanium and wherein the total aluminum and/or titanium content is at most 4.5% by weight based on the total weight of the metal alloy.

64. The plant as claimed in claim 49, wherein the NH₃ decomposition catalyst is nickel-based and, with regard to the decomposition of NH₃ has an apparent activation energy Eapp of at least 50 kJmol−1.

65. The plant as claimed in claim 49, wherein the plant comprises one or more of the following apparatuses that are fluidically connected to one another:
(i) a device for storing liquid NH₃;
(ii) a device for heating and evaporating the liquid NH₃;
(iii) the reactor;
(iv) a device for purifying H₂ from the product gas; and
(v) a device for recovering process heat.

66. The plant as claimed in claim 49, wherein the metal alloy comes into direct contact with gaseous NH₃.

67. The plant as claimed in claim 49, wherein the metal alloy does not come into direct contact with NH₃ in a supercritical state.

68. A method of catalytic decomposition of NH₃ to N₂ and H₂ in a plant as claimed in claim 49, comprising:
introducing the NH₃ into the reactor at a temperature of at least 500° C.
